(19) United States
(12) Patent Application Publication
(10) Pub. No.: US 2015/0114871 A1
(43) Pub. Date: Apr. 30, 2015

(54) VIAL STORAGE AND TRANSPORTATION ASSEMBLY

(71) Applicant: SIO2 MEDICAL PRODUCTS, INC., Auburn, AL (US)

(72) Inventors: Brian Fitzpatrick, West Chester, PA (US); Randy Crenshaw, Opelika, AL (US)

(73) Assignee: SiO2 Medical Products, Inc., Auburn, AL (US)

(21) Appl. No.: 14/404,521

(22) PCT Filed: May 31, 2013
(86) PCT No.: PCT/US13/43642

§ 371 Date: Nov. 28, 2014

Related U.S. Application Data
(60) Provisional application No. 61/654,298, filed on Jun. 1, 2012.

(51) Int. Cl. A61J 1/16; B25J 11/00; B65G 57/02; B01L 9/06; B65B 5/06

(52) U.S. Cl. CPC A61J 1/16; B01L 9/06; B65B 5/068; B65G 57/02; B25J 11/00
USPC 206/508; 206/563; 53/471; 414/801; 414/222.01

(57) ABSTRACT

A vial storage and transportation assembly (10) includes a vial tray (130), a transport lid (100), and a processing lid (200). The transport (100) and the processing lid (200) are interchangeably engageable with the vial tray (30) to house a plurality rt lid vials therein, to shift the assembly (10) between a transport configuration and a processing configuration.

Priority is claimed to U.S. Ser. No. 61/654,298, filed Jun. 1, 2012. That application is incorporated here by reference in its entirety.

### FIELD OF INVENTION

The invention pertains to a vial storage and transportation assembly.

### BACKGROUND

Molded containers, such as vials for housing pharmaceuticals or diagnostic materials, often undergo a series of transportation operations during manufacturing and/or processing. For example, vials treated using plasma enhanced chemical vapor deposition (PECVD) processes typically have to be transferred from a molding location to a coating location. Finished vials, such as those that house pharmaceutical or diagnostic materials often have to undergo further transportation to a sterilization location, followed by a sterilization operation. After sterilization and any other finishing operations, the vials are delivered to a filling line where they undergo a filling operation. These operations can be problematic in the case of such containers that are molded from resins that are prone to scratches, such as cyclic olefin polymer (COP) or cyclic olefin copolymer (COC). A need exists for a device and method for transporting and housing containers in bulk during processing, while minimizing the risk of scratching that can occur when containers come in contact with each other or other objects. A further need exists for such a device and method that can deliver such containers to a filling line, and then deliver filled containers to an end user.

### SUMMARY

The invention relates to a vial storage and transportation assembly, including a vial tray, a transport lid, and a processing lid. The transport lid and the processing lid are interchangeably engageable with the vial tray to house a plurality of vials therein, to shift the assembly between a transport configuration and a processing configuration.

The invention further relates to a vial storage and transportation assembly including a vial tray having a substantially planar base and a plurality of receptacles extending downwardly therefrom. Each of the receptacles has a substantially cylindrical body closed off by a bottom wall having a downwardly extending protrusion. The assembly further includes a transport lid having a substantially planar base and a plurality of bumps extending upwardly therefrom. Each of the bumps has a substantially cylindrical body closed off by a top wall having a downwardly extending indentation. Each of the indentations is configured to receive a selected one of the protrusions of a second assembly, so as to permit stacking of multiple assemblies.

The invention further relates to a vial storage and transportation assembly including a vial tray having a substantially planar base and a plurality of receptacles extending downwardly therefrom. Each of the receptacles is configured to retain a vial in an inverted position therein. The assembly further includes a processing lid that slidably engages the vial tray to enclose a plurality of vials therein.

The invention further relates to a method for transporting a plurality of vials, including providing a first vial storage and transportation assembly. The first assembly includes a vial tray having a substantially planar base and a plurality of receptacles extending downwardly therefrom. Each of the receptacles has a substantially cylindrical body closed off by a bottom wall having a downwardly extending protrusion. The assembly further includes a transport lid having a substantially planar base and a plurality of bumps extending upwardly therefrom. Each of the bumps has a substantially cylindrical body closed off by a top wall having a downwardly extending indentation. Each one of the indentations is configured to receive a selected one of the protrusions of a second vial storage and transportation assembly, so as to permit stacking of multiple assemblies. The method further includes providing a plurality of vials, each having an interior and an opening located at a top portion thereof and leading to the interior. The method further includes inverting and placing a top portion of each of the vials within the receptacles such that the opening of each vial faces the bottom wall of one of the receptacles, and placing the transport lid over the vials and in engagement with the vial tray, such that the vials are substantially enclosed between the vial tray and the transport lid, and one of the bumps houses a bottom portion of each of the vials. The method still further includes transporting the vials within the first assembly.

The invention further relates to a method of processing a plurality of vials. The method includes providing a vial storage and transportation assembly. The assembly includes a vial tray having a substantially planar base and a plurality of receptacles extending downwardly therefrom. Each of the receptacles has a substantially cylindrical body closed off by a bottom wall. The assembly further includes a processing lid that slidably engages the vial tray. The method further includes providing a plurality of vials, each having an interior and an opening located at a top portion thereof and leading to the interior. The method further includes inverting and placing a top portion of each of the vials within the receptacles such that the opening of each vial faces the bottom wall of one of the receptacles, and placing the processing lid over the vials and in engagement with the vial tray, such that the vials are substantially enclosed between the vial tray and the processing lid. The method still further includes subjecting the vials to a processing operation within the assembly.

The present invention still further relates to a method of transporting and processing a plurality of vials. The method includes providing a vial storage and transportation assembly. The assembly includes a vial tray having a substantially planar base and a plurality of receptacles extending downwardly therefrom. The assembly also includes a transport lid having a substantially planar base and a plurality of bumps extending upwardly therefrom, and a processing lid that engages the vial tray interchangeably with the transport lid. The method further includes providing a plurality of vials. Each of the vials has an interior and an opening located at a top portion thereof and leading to the interior. The method further includes inverting and placing a top portion of each of the vials within the receptacles such that the opening of each vial faces the bottom wall of one of the receptacles. The method further includes placing the transport lid over the vials and in engagement with the vial tray, such that the vials are substantially enclosed between the vial tray and the transport lid, and one of the bumps houses a bottom portion of each of the vials. The method further includes transporting the vials within the assembly, removing the transport lid from the vial tray, and placing the processing lid over the vials and in engagement with the vial tray, such that the vials are substantially enclosed between the vial tray and the processing lid. The method still further includes subjecting the vials to a processing operation within the assembly.

### BRIEF DESCRIPTION OF THE DRAWINGS

FIG. 1 is a top perspective view of a tray of a first embodiment of a vial storage and transportation assembly in accordance with the invention, with a vial seated therein;

FIG. 2 is an enlarged detail of FIG. 1;

FIG. 3 is a bottom perspective view of the tray of FIG. 1;

FIG. 4 is an enlarged detail of FIG. 3;

FIG. 5 is a top plan view of the tray of FIG. 1;

FIG. 6 is a bottom plan view of the tray of FIG. 1;

FIG. 7 is front elevational view of the tray of FIG. 1;

FIG. 8 is a left side elevational view of the tray of FIG. 1;

FIG. 9 is top perspective view of a transport lid of a vial storage and transportation assembly in accordance with the invention;

FIG. 10 is an enlarged detail of FIG. 9;

FIG. 11 is a bottom perspective view of the transport lid of FIG. 9;

FIG. 12 is an enlarged detail of FIG. 11;

FIG. 13 is a top plan view of the transport lid of FIG. 11;

FIG. 14 is a bottom plan view of the transport lid of FIG. 11;

FIG. 15 is a front elevational view of the transport lid of FIG. 11;

FIG. 16 is a left side elevational view of the transport lid of FIG. 11;

FIG. 17 is a top perspective view of the transport lid of FIG. 11 engaged with the vial tray of FIG. 1;

FIG. 18 is an enlarged detail of FIG. 17;

FIG. 19 is a cross section taken along line 19-19 of FIG. 17;

FIG. 20 is a cross section taken along line 20-20 of FIG. 17;

FIG. 21 is an enlarged detail of FIG. 20;

FIG. 22 is a top perspective view of a transport lid and vial tray, as shown in FIG. 17, with a second vial tray stacked atop the transport lid;

FIG. 23 is an enlarged detail of FIG. 22;

FIG. 24 is a cross-section taken along line 24-24 of FIG. 22;

FIG. 25 is an enlarged detail of FIG. 24;

FIG. 26 is a top perspective view of a processing lid of a vial storage and transportation assembly in accordance with the invention;

FIG. 27 is a bottom perspective view of the processing lid of FIG. 26;

FIG. 28 is a top plan view of the processing lid of FIG. 26;

FIG. 29 is a bottom plan view of the processing lid of FIG. 26;

FIG. 30 is a front elevational view of the processing lid of FIG. 26;

FIG. 31 is a left side elevational view of the processing lid of FIG. 26;

FIG. 32 is a top perspective view of the processing lid of FIG. 26 engaged with the vial tray of FIG. 1;

FIG. 33 is an enlarged detail of FIG. 32;

FIG. 34 is a perspective view of an exemplary vial for use with the vial storage and transportation assembly of the invention;

FIGS. 35A-F show stages of a process for preparing vials stored in the assembly for transfer to a filling line;

FIG. 36 is a perspective view of the assembly with the tray and processing lid, and a sheet of selectively permeable material covering the processing lid, for processing of vials within the assembly;

FIG. 37 is a top perspective view of a tray of a second embodiment of a vial storage and transportation assembly in accordance with the invention, with a vial seated therein;

FIG. 38 is a bottom perspective view of the tray of FIG. 37;

FIG. 39 is a top perspective view of a transport lid of a vial storage and transportation assembly in accordance with the invention;

FIG. 40 is a bottom perspective view of the transport lid of FIG. 37;

FIG. 41 is a top perspective view of the transport lid of FIG. 39 engaged with the vial tray of FIG. 37;

FIG. 42 is a top perspective view of a processing lid of a vial storage and transportation assembly in accordance with the invention;

FIG. 43 is a bottom perspective view of the processing lid of FIG. 42;

FIGS. 44A-F show stages of a process for preparing vials stored in the assembly for transfer to a filling line; and

FIG. 45 is a top perspective view of the processing lid of FIG. 42 engaged with the vial tray of FIG. 37.

### DETAILED DESCRIPTION OF THE PREFERRED EMBODIMENTS

Certain terminology is used in the foregoing description for convenience and is not intended to be limiting. Words such as “front,” “back,” “top,” and “bottom” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

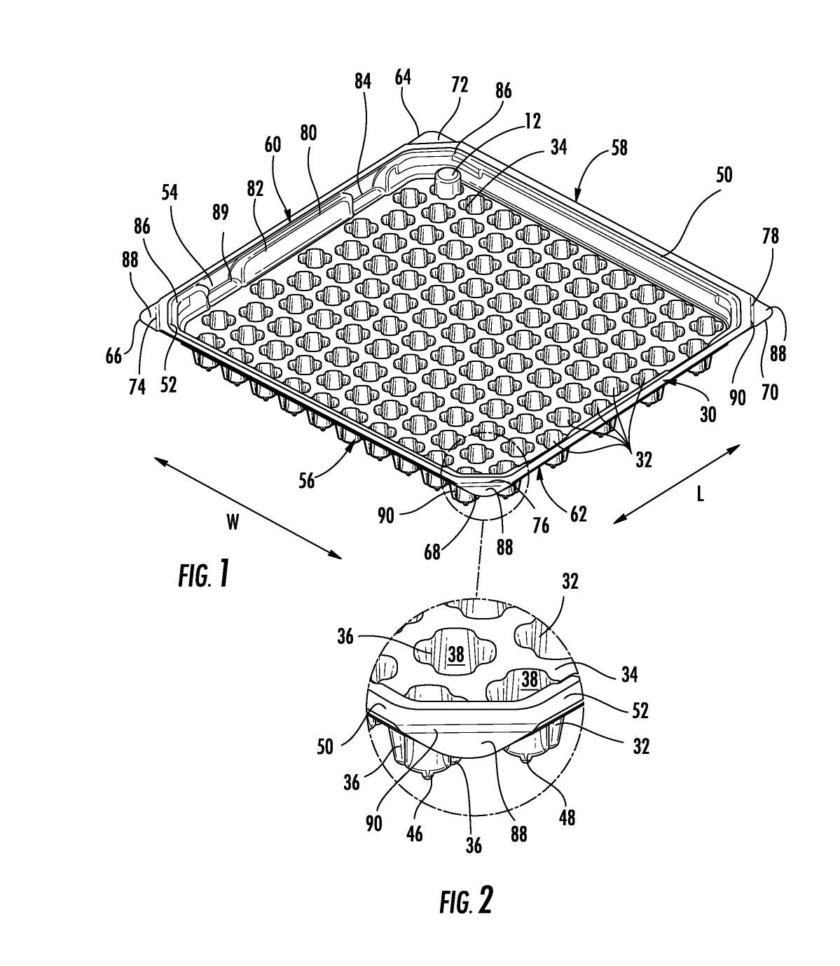

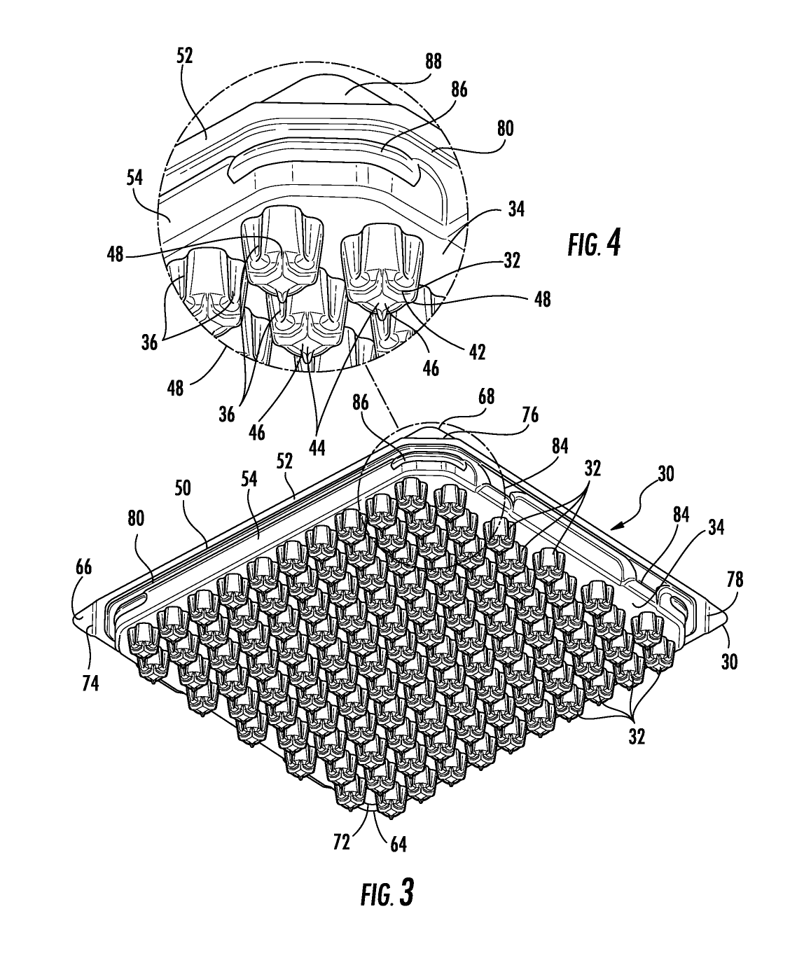

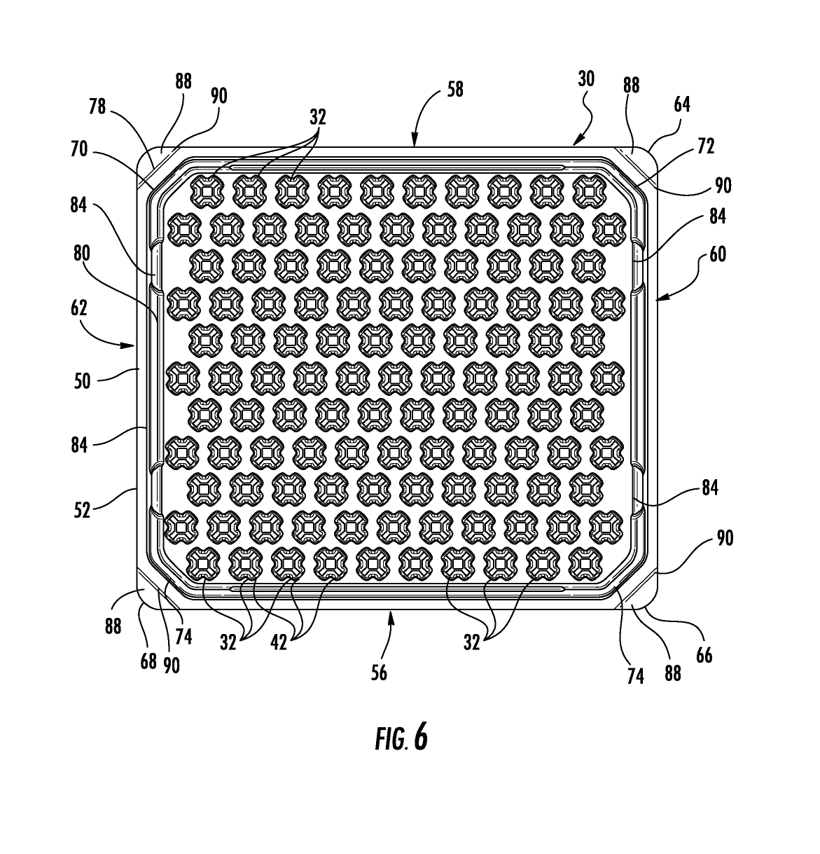

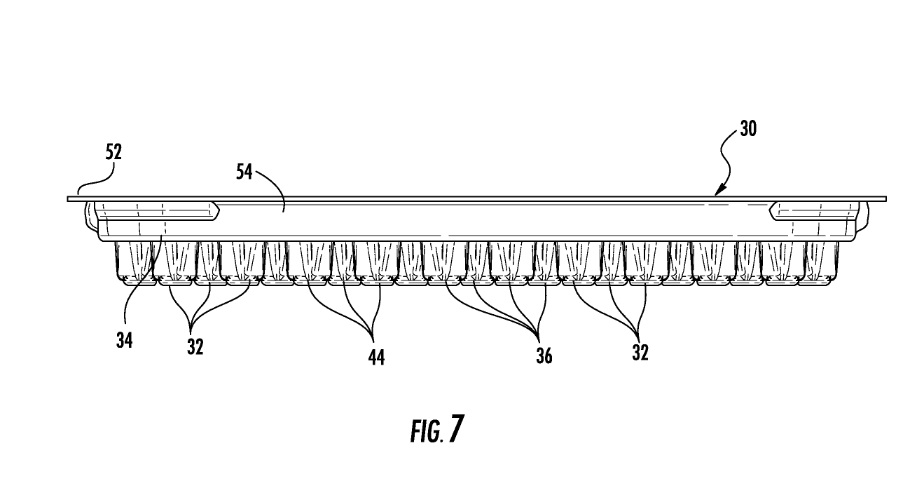

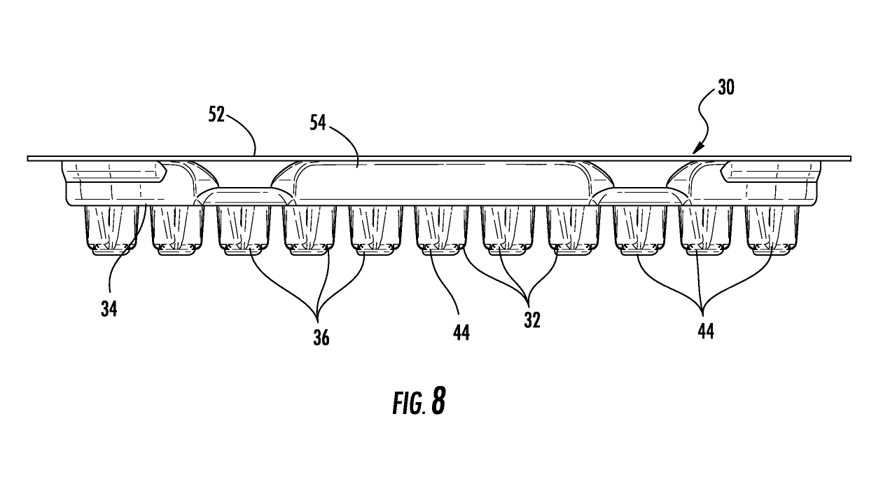

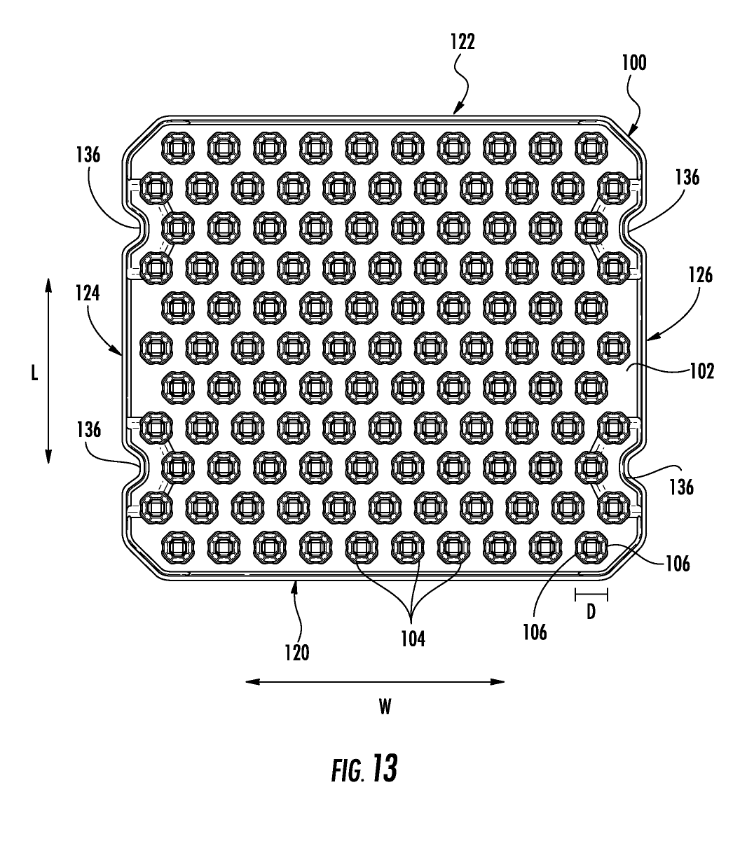

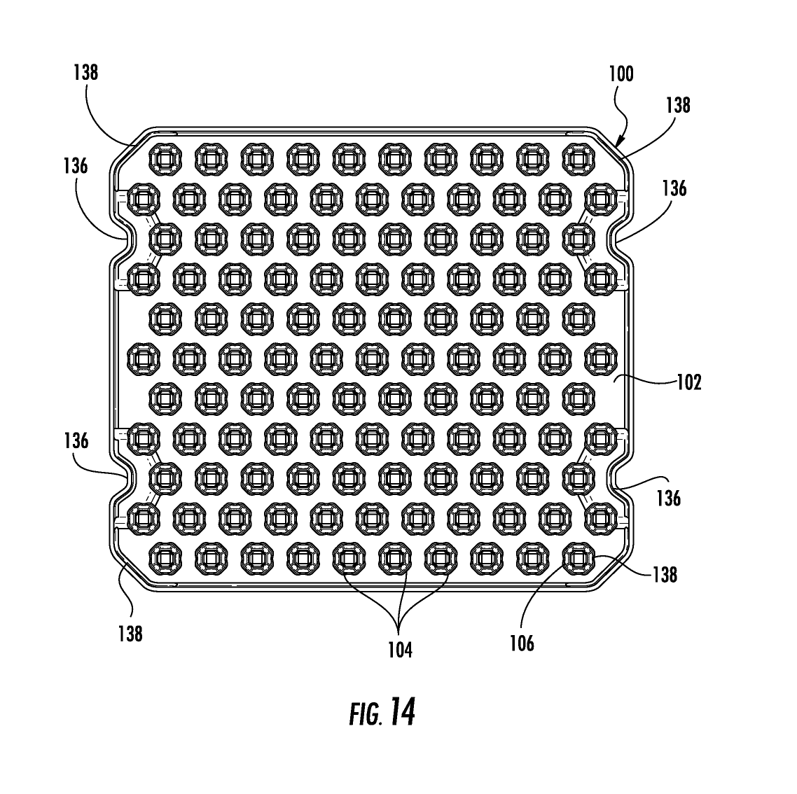

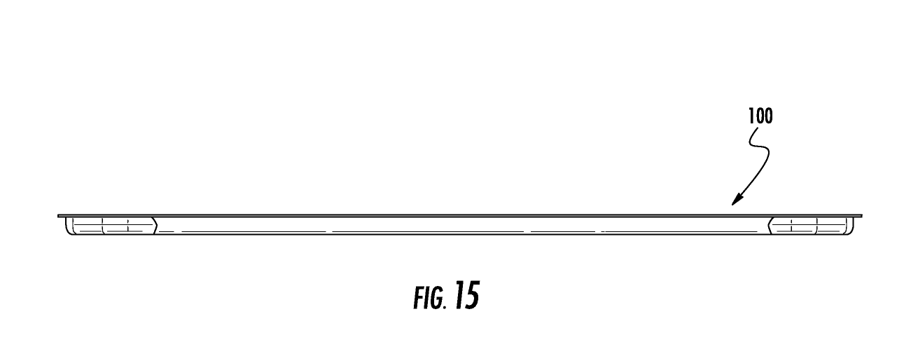

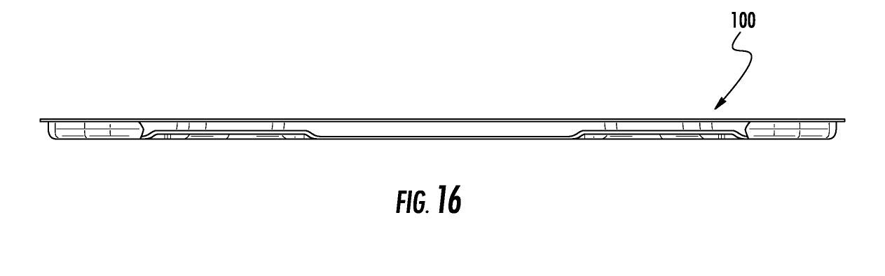

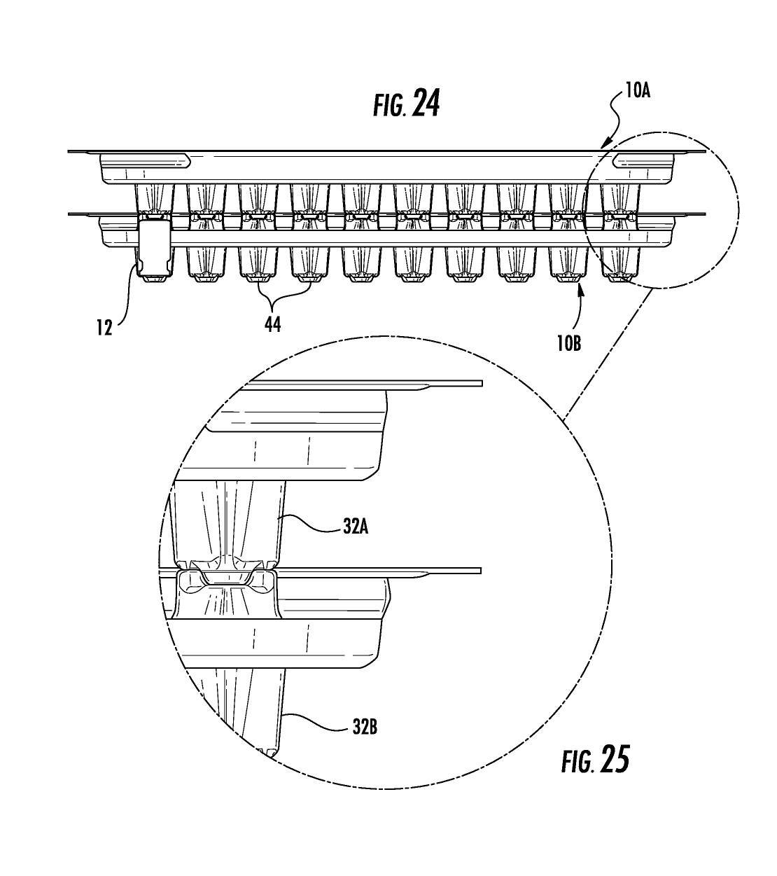

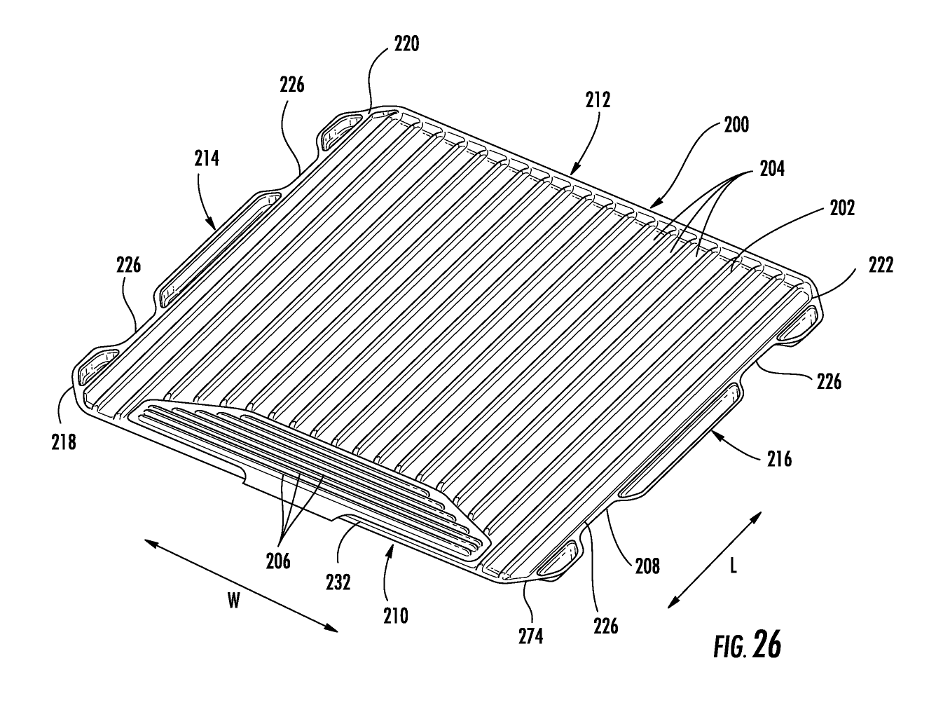

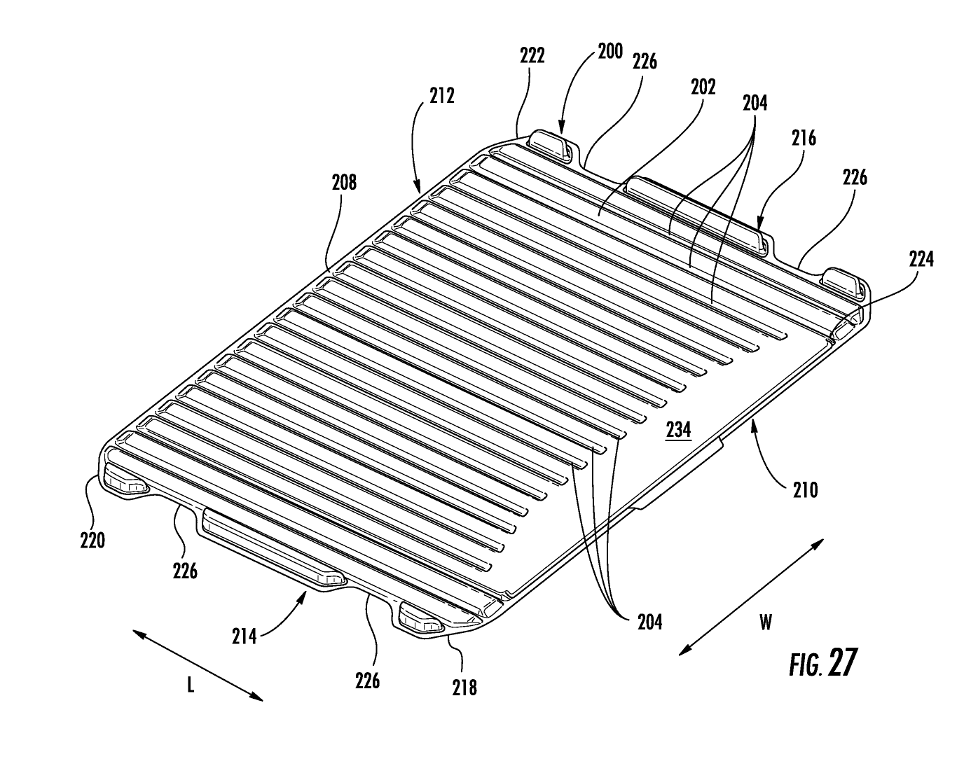

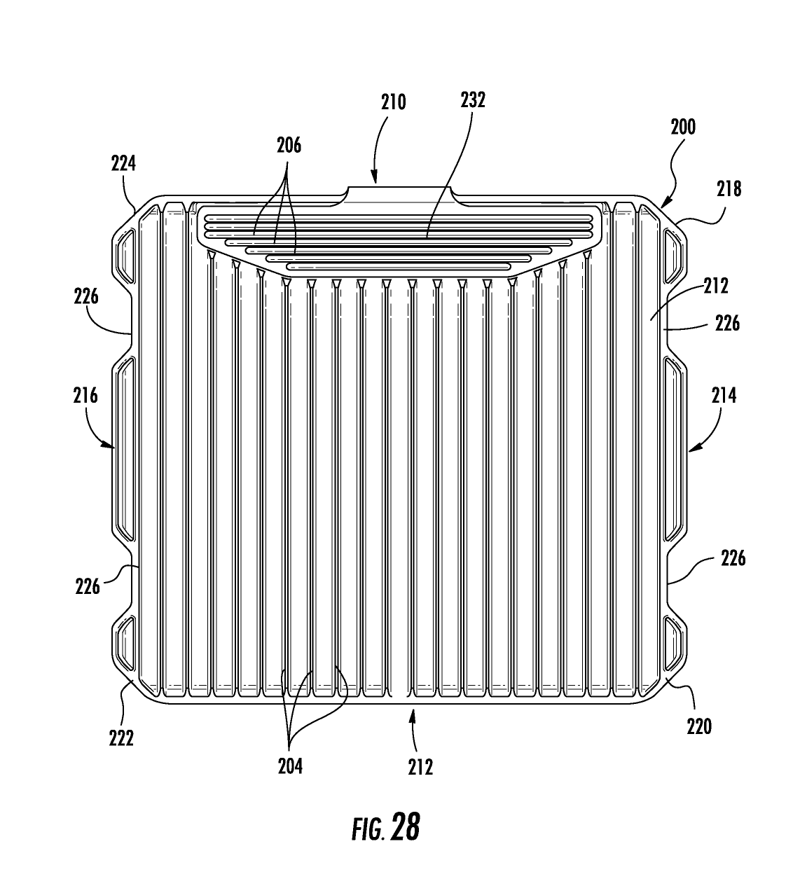

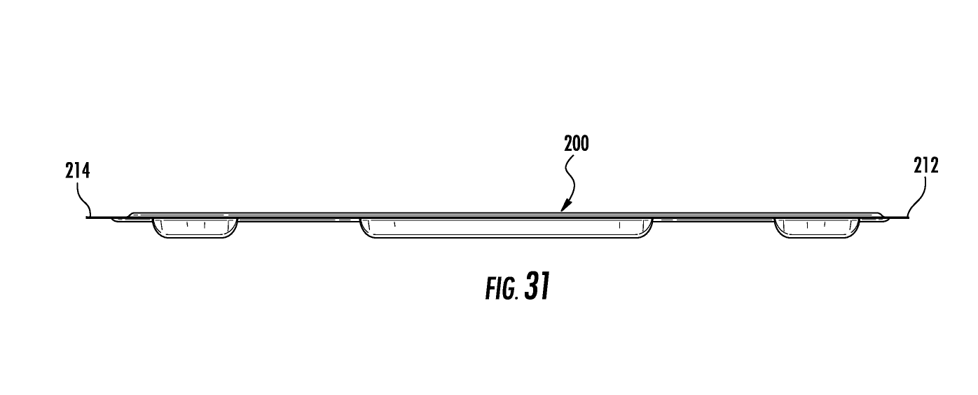

A first embodiment of a vial storage and transportation assembly 10 according to the invention is shown in FIGS. 1-36. As shown, the assembly 10 includes a tray 30, a transport lid 100, and a processing lid 200. The tray 30 includes a plurality of receptacles 32 that seat a plurality of vials 12. The transport lid 100 and the processing lid 200 interchangeably fit over the tray 30 and the vials 12 seated therein for housing the vials 12 during transport and processing operations thereof.

The tray 30 is shown in detail in FIGS. 1-8. As shown, the tray 30 includes a base 34, which is formed as a substantially planar wall. The receptacles 32 extend downward from the base 34 and are configured for receiving portions of the vials 12. In the illustrated embodiment, one-hundred and fifteen receptacles 32 are defined in the base 34, though fewer or more receptacles 32 could be provided as well, depending on the number of vials 12 to be housed in the assembly 10. Also in the illustrated embodiment, the tray 30 has a length L and a width W. The receptacles 32 are provided in rows extending along the width W of the tray 30, the rows alternating between having ten and eleven receptacles 32, with the alignment of the rows along the length L of the tray 30 being staggered. This configuration permits the maximum number of receptacles 32 to be provided, while maintaining the maximum distance between adjacent receptacles 32, so as to minimize the risk of adjacent vials 12 coming into contact with each other, which could potentially damage the vials 12, such as by scratching. In other embodiments, the receptacles could be aligned in rows and columns along the length L and width W directions.

An exemplary vial 12 for use with the assembly 10 is shown in FIG. 34. The vial 12 of this embodiment has a configuration typical of that of vials for storage of parenteral drugs. As shown, the vial 12 includes substantially cylindrical body 14, which is closed off by a base wall 16, and defines an interior 18 therein. A substantially cylindrical neck 20 having a diameter less than that of the body 14 extends upward therefrom and defines an opening 22 leading to the interior 18. A rim 24 extends around the opening 22.

Referring to FIG. 1, vials 12 are stored in the tray in an inverted orientation, such that the opening 22, rim 24, neck 20, and upper portion of the cylindrical body 14 are all housed within a receptacle 32, and the lower portion of the body 14 and the base wall 16 extend outward and upward therefrom. Orienting the vials 12 in this manner within the tray 30 prevents entry of contaminants that could enter the vial interior 18 if the vial 12 were positioned upright, with the opening 22 located at the top thereof.

Each of the receptacles 32 is sized and shaped to receive and securely hold a portion of a single vial 12. As shown in FIGS. 1-8, each receptacle 32 has a substantially cylindrical shape, with the cylinder diameter being slightly greater than the outer diameter of the vial body 14 to be stored therein. Within each receptacle 32 is defined a portion of a vial seating space 38. Four longitudinal ribs 36 extend in an axial direction along the length of each receptacle 32 and protrude into the vial seating space 38. As shown, the longitudinal ribs 36 impart each receptacle 32 with a substantially four-lobed shape. While four longitudinal ribs 36 are shown in the illustrated embodiment, it should be understood that fewer or more longitudinal ribs 36 could be provided as well. Also in the illustrated embodiment, the longitudinal ribs 36 are substantially equally spaced about the circumference of the receptacle 32. The provision of four longitudinal ribs 36 results in two sets of two ribs being located directly across from each other along the circumference of the cylindrical receptacle 32. Referring in particular to FIG. 5, the distance D between the innermost points of two ribs 36 located directly across from each other is substantially equal to the diameter of the vial body 14 seated therein. The distance D may be slightly less than the diameter of the vial body 14, such that when the vial body 14 is inserted, the receptacle 32 undergoes deformation to produce an interference fit between the ribs 36 and the vial body 14. As can also be seen in FIG. 5, gaps 40 are formed between the outer surface of the vial body 14 and the inner surface of the receptacle 32, at locations between the ribs 36. Gaps 40 facilitate entry of gas into the vial interiors 18, for example during processing, as described in detail below.

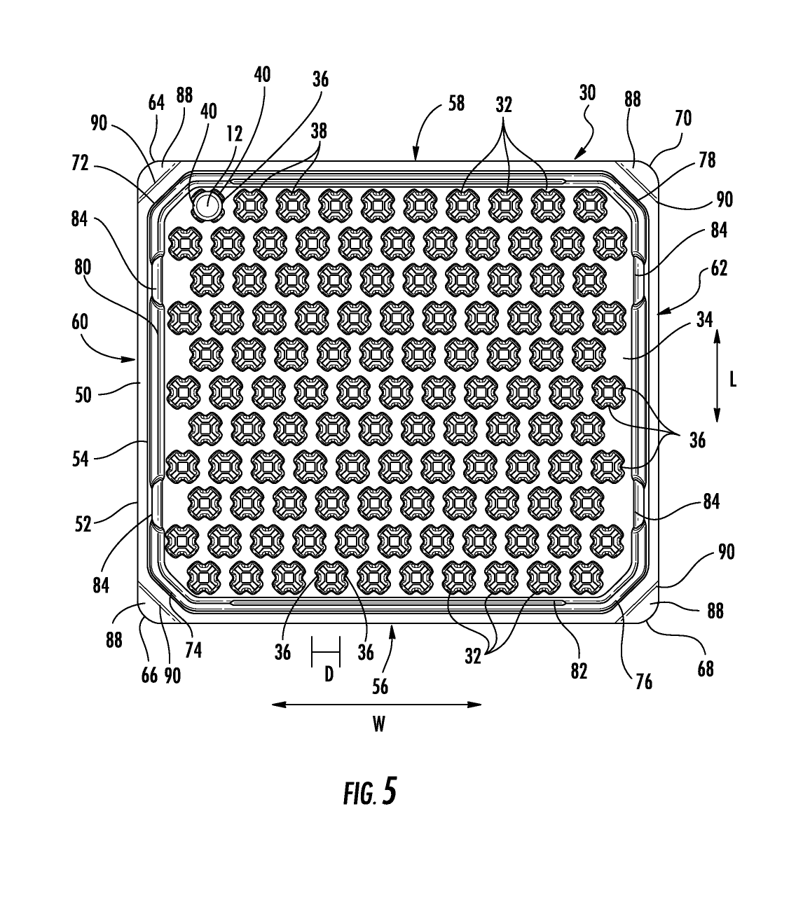

Each receptacle 32 is closed off by a bottom wall 42, as shown in detail in FIGS. 3, 4 and 6. As shown, a protrusion 44 extends downward from each bottom wall 42, outward from the vial receiving space 38. Each protrusion 44 has a substantially square central portion 46, with four ribs 48 extending outward from the four corners thereof. The ribs 48 extend at substantially 45° angles with respect to the length L and width W directions, such that the end of each rib 48 terminates at a circumferential position between two adjacent longitudinal ribs 36.

The tray 30 further includes an outer rim 50 surrounding the receptacles 32. As shown in FIGS. 1-8, the rim 50 includes an outer wall 52 that substantially forms an outer border of the tray 30. The outer wall 52 is substantially parallel to and upwardly displaced from the base 34 and joined thereto by a connecting wall 54 that is substantially perpendicular to both the base 34 and the outer wall 52, and vertical in the illustrated embodiment. The rim 50, and in turn the outer perimeter of the tray 30 includes a front edge 56, a back edge 58, a left edge 60 and a right edge 62. Joining the edges are a first corner 64, second corner 66, third corner 68, and fourth corner 70. Corner depressions 88 may be formed in the outer wall. As shown in FIG. 1, the corner depressions are depressed areas of the outer wall that are substantially parallel to, but lower than the remainder of outer wall 52. The corner depressions each include one of the four corners 64, 66, 68, 70, and may be separated from the remainder of the outer wall 52 by a step, such as the diagonally extending steps 90 of the illustrated embodiment.

As shown in FIG. 5, the rim outer wall 52 and connecting wall 54 extend parallel to the front edge 56, back edge 58, left edge 60 and right edge 62, but cut across the corners 64, 66, 68, 70 by way of diagonal sections 72, 74, 76, 78. A ridge 80 protrudes inward from connecting wall 52 and upward from base 35. Ridge 80 follows connecting wall 54 around the perimeter of the base 34, along or parallel to the edges 56, 58, 60, 62 and diagonal sections 72, 74, 76, 78. A shoulder 82 is formed at an upper and innermost portion of ridge 80. Shoulder 82 may be formed as a sharp, or as shown in the illustrated embodiment, soft corner at an apex of ridge 80. At least one interruption 84 is formed in ridge 80, at which the connecting wall 54 joins directly with the base 34. Four interruptions 84 are provided in the illustrated embodiment, two being provided parallel to the left edge 60 and two being provided parallel to the right edge 62, but more or fewer interruptions 84 could be provided as well and the locations and sizes of the interruptions 84 could be varied. One or more grooves 86 may be defined in the ridge 80 to facilitate engagement with the transport lid 100 or processing lid 200. In the illustrated embodiment, four grooves 86 are provided, each extending along the ridge 80 parallel to a diagonal section, and partially parallel to the front, back, left and right 56, 58, 60, 62.

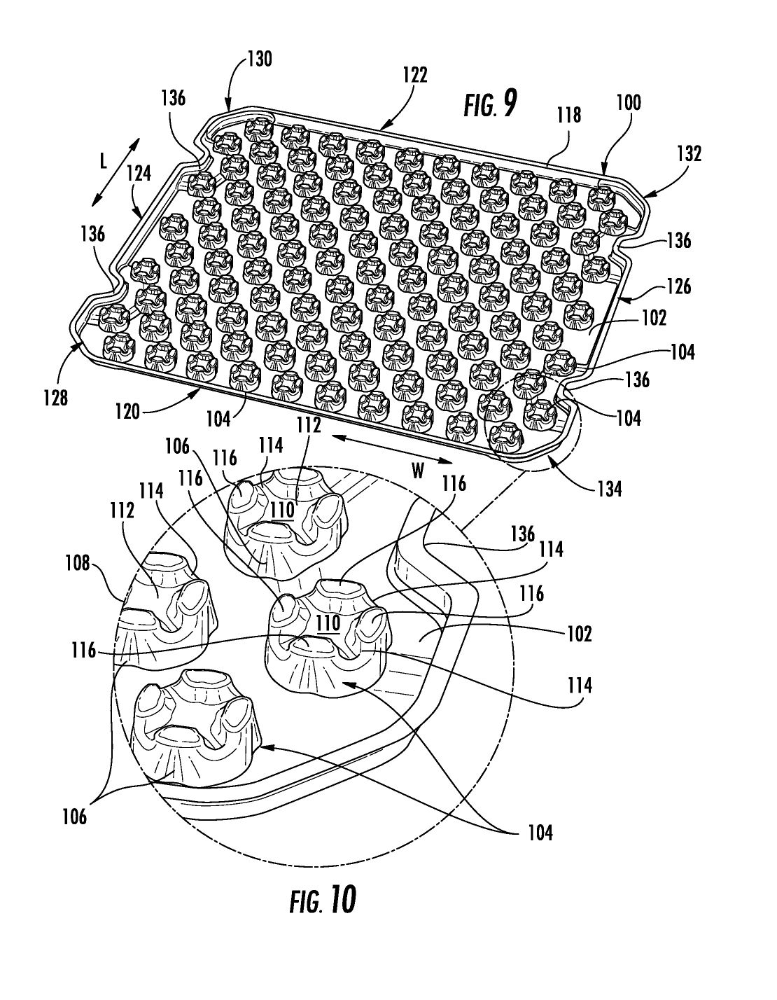

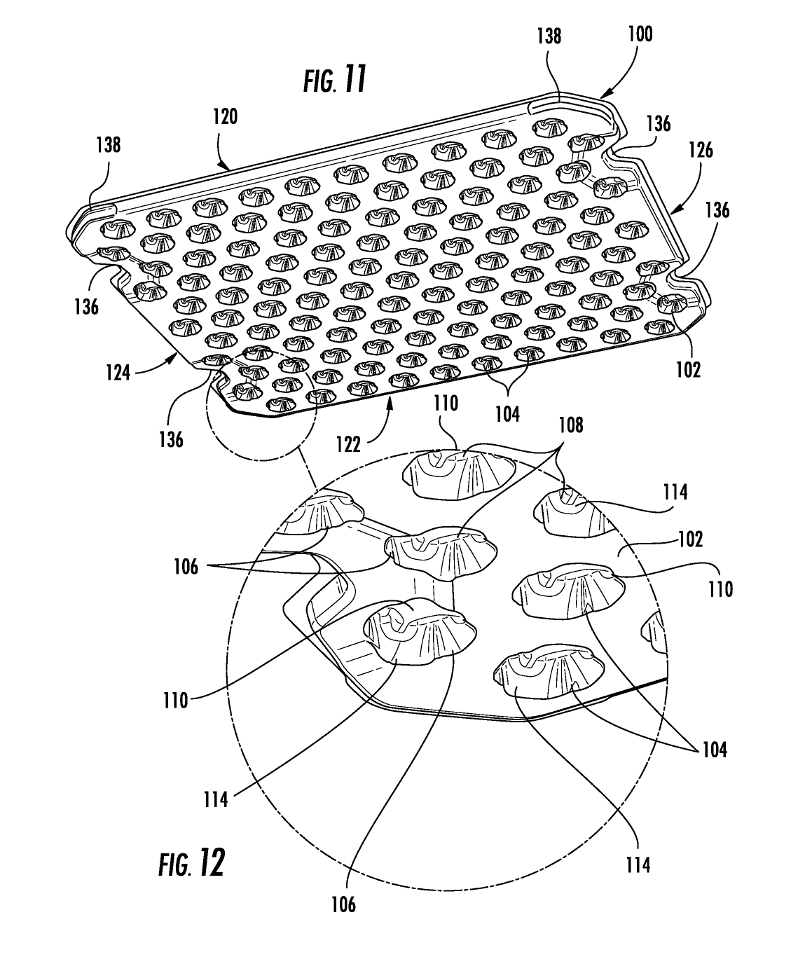

An embodiment of a transport lid 100 according to the invention is shown in detail in FIGS. 9-16. The transport lid 100 is configured for engagement with the tray 30, as described in detail below. The transport lid 100 includes a base 102, which is formed as a substantially planar wall. A plurality of bumps 104 extend upward from the base and are configured for receiving the portions of the vials 12 not retained by the receptacles 32 of the tray 30. The bumps 104 are formed at locations on the base 102 that are aligned with the receptacles 32 of the tray 30 when the base 102 is engaged with the tray 30. Accordingly, the number and distribution of the bumps 104 are the same as those of the receptacles 32.

Whereas the receptacles 32 are each sized and shaped to hold an upper portion of a single vial 12 in the inverted condition, each of the bumps 104 is sized and shaped to hold a lower portion of a single vial 12 in the inverted condition. Accordingly, each bump 104 has a substantially cylindrical configuration, with the cylinder diameter being slightly greater than the outer diameter of the vial body 14 to be stored therein. An upper portion of the vial seating space 38 is defined within each bump 104, such that each receptacle 32 and aligned bump 104 together define one entire vial seating space 38, with the receptacle defining the lower portion thereof, which houses the upper portion of the inverted vial 12, and the bump 104 defining the upper portion thereof, which houses the lower portion of the inverted vial 12.

Four longitudinal ribs 106 extend along the length of each bump 104 and protrude into the vial seating space 38. As shown, the longitudinal ribs 106 impart each protrusion with a substantially four-lobed shape that aligns with the four-lobed shape of the receptacle 32 when the transport lid 100 is assembled on the tray 30. While four longitudinal ribs 106 are shown in the illustrated embodiment, it should be understood that fewer or more longitudinal ribs 106 could be provided as well. In the illustrated embodiment, the longitudinal ribs 106 are substantially equally spaced about the circumference of the bump 104. The provision of four longitudinal ribs 106 results in two sets of two ribs being located directly across from each other about the circumference of the bump 104. Referring in particular to FIG. 13, the distance D between the innermost points of two ribs located directly across from each other is substantially equal to the diameter of the vial body 14 seated therein. The distance D may be slightly less than the diameter of the vial body, such that when the transport lid 100 is engaged with the tray 30, the bump 104 undergoes deformation to produce an interference fit between the ribs 106 and the vial body 14.

Each bump 104 is closed off by a top wall 108, as shown in detail in FIGS. 9, 10 and 12. As shown, an indentation 110 extends downward from each top wall 108, into the vial receiving space 38. Each indentation is sized and shaped similarly to the protrusions 44 of the bottom wall 42, and in particular, is formed complementary to and capable of receiving and interlocking with the protrusions of the bottom wall, so as to allow stacking of a second tray 30 atop the transport lid 100 when engaged with a first tray 30, as described in detail below. Accordingly, each indentation 100 has a substantially square central portion 112, with four channels 114 extending outward from the four corners thereof. The channels 114 extend at substantially 45° angles, such that the end of each channel 114 falls at a circumferential position between two adjacent longitudinal ribs 106. Four protuberances 116 are defined surrounding the square central portion 112 and between adjacent channels 114.

The transport lid 100 further includes an outer rim 118 surrounding the bumps 104. As shown in FIGS. 9-14, the rim 118 forms an upward step that extends around the perimeter of the transport lid 100, configured to mate with the shoulder 82 of the tray 30 when the transport lid 100 is engaged with the tray 30. The rim 118, and in turn the outer perimeter of the transport lid 100 includes a front edge 120, a back edge 122, a left edge 124, and a right edge 126, each being adjoined with the adjacent edge by way of diagonal sections 128, 130, 132, 134. The edges 120, 122, 124, 126 extend in substantially straight paths, with the exception of one or more indentations 136 defined in the rim 118 and in turn the edge of the transport lid 100. The indentations 136 of the illustrated embodiment are located at positions aligned with interruptions 84 of the tray 30 when the transport lid 100 is engaged with the tray 30. Specifically, two indentations 136 are formed in the left edge 124 and two indentations 136 are formed in the right edge 126 in the embodiment shown.

One or more elongate projections 138 may extend from a bottom surface of the rim 118 at locations aligned with the grooves 86 of the ridge 80 formed in the tray 30. The elongate projections are sized and shaped to be received by the grooves 86 when the transport lid 100 is engaged with the tray 30.

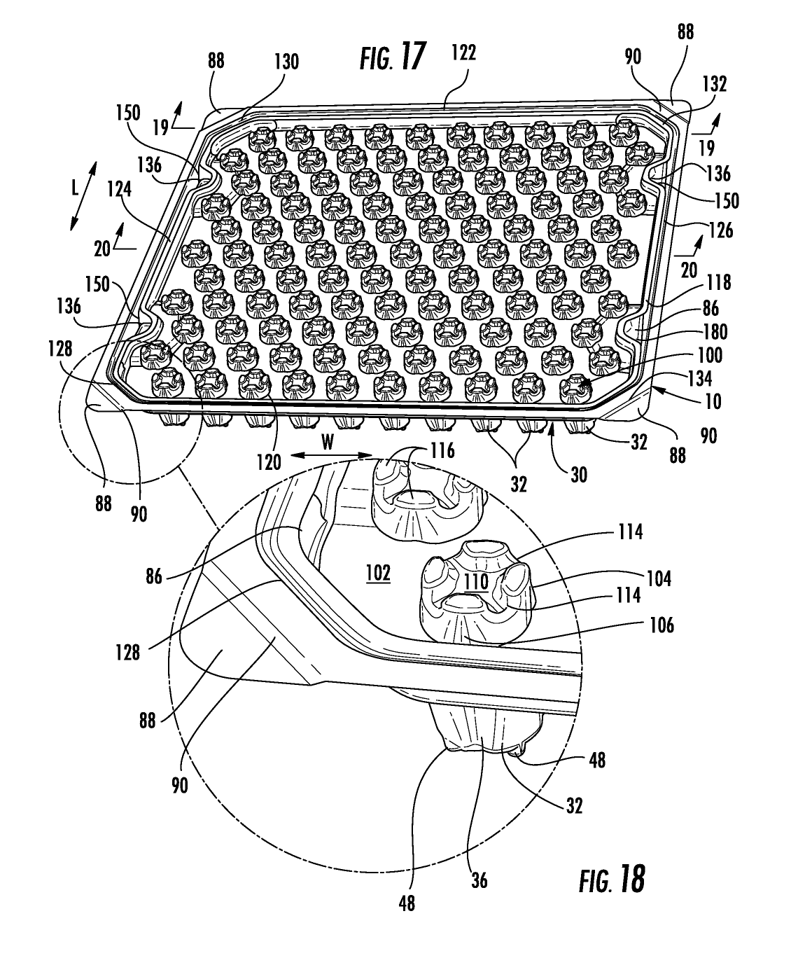

Referring to FIGS. 17-20, the tray 30 and transport lid 100 are shown in engagement with each other, such that the transport lid 100 closes the receptacles 38 and substantially covers and encloses the vials 12 stored therein. As shown, the rim 118 of transport lid 100 engages the shoulder 82 of the tray 30 and elongate projections 138 are held within grooves 86 to substantially affix the transport lid 100 to the vial tray 30 in a snapping engagement. The use of such a snapping engagement helps to secure the transport lid 100 on the tray 30 so that it does not become disengaged when the assembly 10 is being transported or when multiple assemblies 10 are stacked. A connection is formed between the transport lid 100 and the vial tray 30 substantially about the perimeters thereof, with the exception of the regions where indentations 136 of the transport lid 100 are aligned with interruptions 84 of the tray 30, between which openings 150 are defined.

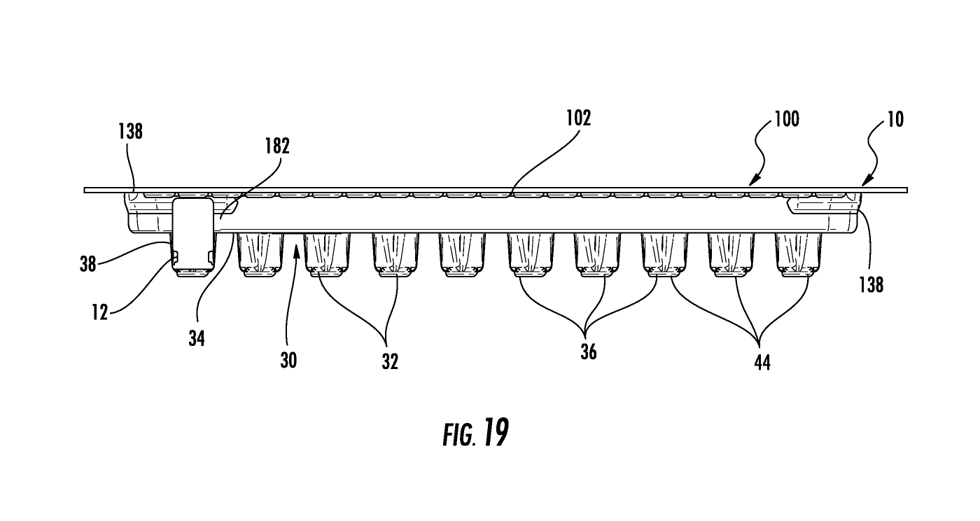

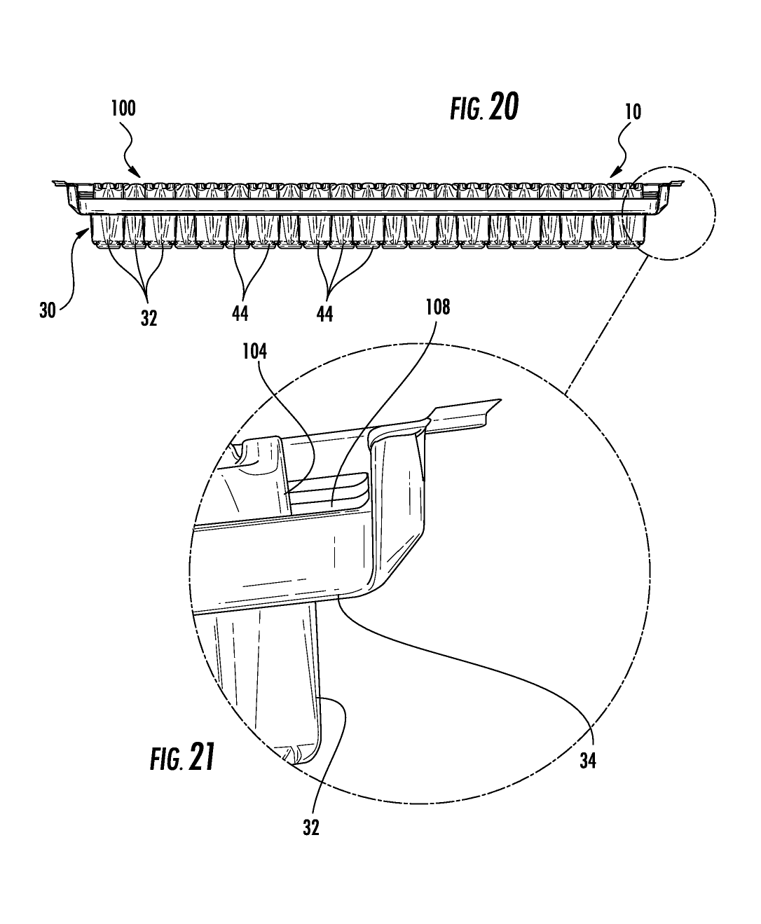

Openings 150 facilitate removal of the transport lid 100 from the tray 30. To remove the transport lid 100 from the tray 30, a user's fingers can be inserted into the openings 150 and engaged with the rim 118 in the area of the indentations 136 in order to disengage the transport lid 100 from the tray 30. Openings 150 can also be utilized to permit entry of gas into the interior of the assembly 10, for example, in an embodiment where the processing lid 200 is omitted and the transport lid 100 used for both transport and processing in which entry of gas into the vial interiors 18 is necessary, such as sterilization. As shown in FIG. 19, a space 152 is formed between the base 34 of tray 30 and the base 102 of transport lid 100. Gas from the outside environment can enter the assembly via openings 150 and flow therethrough via space 152. This gas can come in contact with all exposed outside surfaces of the vial 12. Additionally, gas can travel to the interior 18 of the vial 12 by entering gaps 40 and then traveling through channels 114 to the opening 22 of the vial 12.

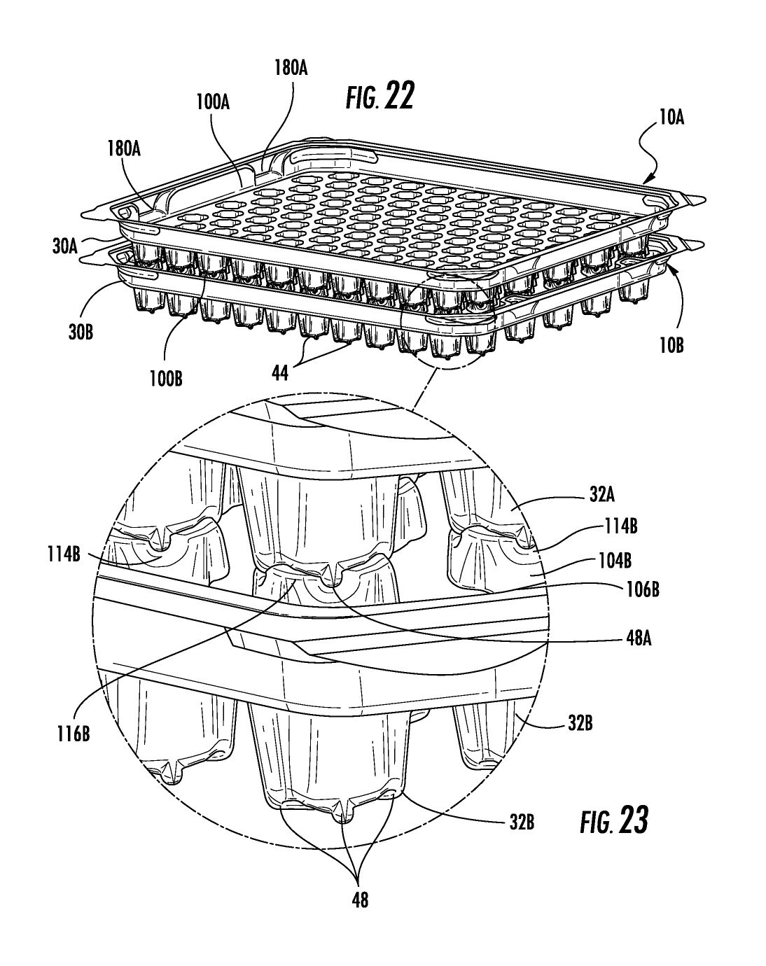

Multiple assemblies having the transport lid 100 affixed to the tray 30, as described above, can be stacked, as shown in FIGS. 22-25. In the configuration shown, an upper assembly 10A including a tray 30A and transport lid 100A is stacked on top of a lower assembly 10B including a tray 30B and transport lid 100B. In this configuration, the tray 30A of the upper assembly 10A sits upon the transport lid 100B of the lower assembly 10B. Each of the upper assembly receptacles 32A sits upon a lower assembly bump 104B, with the receptacle bottom walls 42A resting on the bump top walls 108B. Protrusions 44A are received within indentations 110B, with protrusion square central portions 46A fitting within indentation square central portions 112B, and ribs 48A fitting within channels 114B. Protuberances 116B between channels 114B fit between adjacent ribs 48A to further help retain the tray 30A in a fixed position upon transport lid 100B. Each receptacle 32A mates with a corresponding bump 104B in this manner, as shown in FIGS. 22 and 23. Any number of assemblies 10 can be stacked in this manner, to facilitate transporting of multiple assemblies at one time. In one embodiment, the transport lid 100 and tray 30 of each assembly 10 can be further detachably affixed together, for example by adhesives or tape that can be disengaged when removal of the transport lid 100 from the tray 30 is desired.

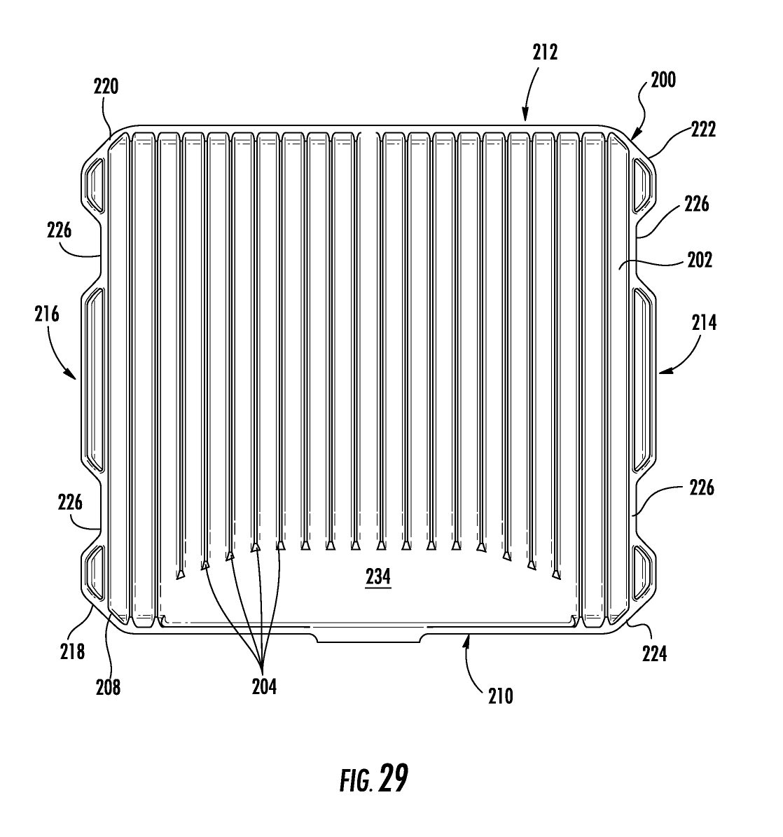

An embodiment of a processing lid 200 according to the invention is shown in detail in FIGS. 26-31. The processing lid 200 is configured for engagement with the tray 30, as described in detail below. In particular, the transport lid 100 and the processing lid 200 are configured for interchangeable engagement with the tray 30.

The processing lid 200 includes a base 202, which is formed as a substantially planar wall. A plurality of creases may be formed in the base 202 in order to add stiffness. The processing lid 200 of the illustrated embodiment includes a set of longitudinal creases 204 extending in a lengthwise direction of the processing lid 200 and a set of transverse creases 206 extending in a widthwise direction of the processing lid 200, both sets of creases projecting upwards from the upper surface of the base 202.

The processing lid 200 further includes an outer border 208 surrounding the region of the creases 204, 206. The outer border 208 is formed as an extension of base 202 and is coplanar therewith. The outer border 208, and in turn the outer perimeter of the processing lid 200 includes a front edge 210, a back edge 212, a left edge 214, and a right edge 216, each being adjoined with the adjacent edge by way of diagonal sections 218, 220, 222 , 224. The edges 210, 212, 214, 216 extend in substantially straight paths, with the exception of one or more indentations 226 defined in the border 208 and in turn the edge of processing lid 200. The indentations 226 of the illustrated embodiment are located at positions aligned with interruptions 84 of the tray 30 when the processing lid 200 is engaged with the tray. Specifically, two indentations 226 are formed in the left edge 214 and two indentations 226 are formed in the right edge 216 in the embodiment shown.

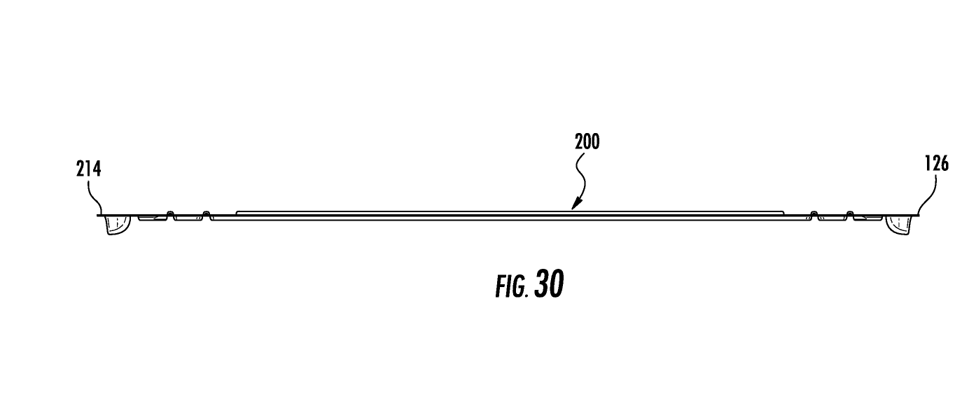

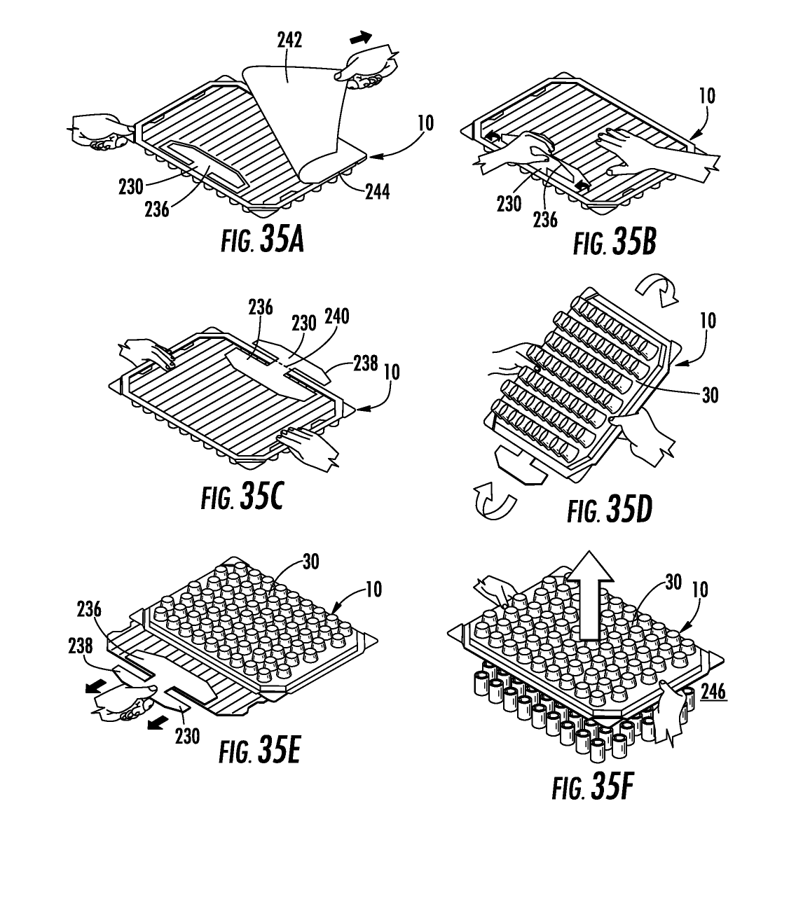

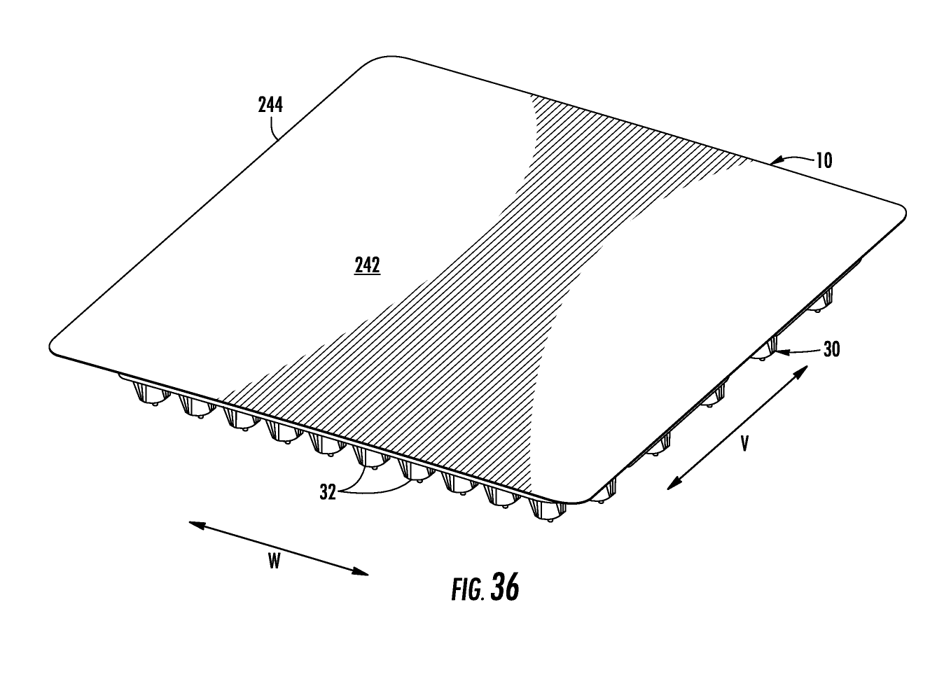

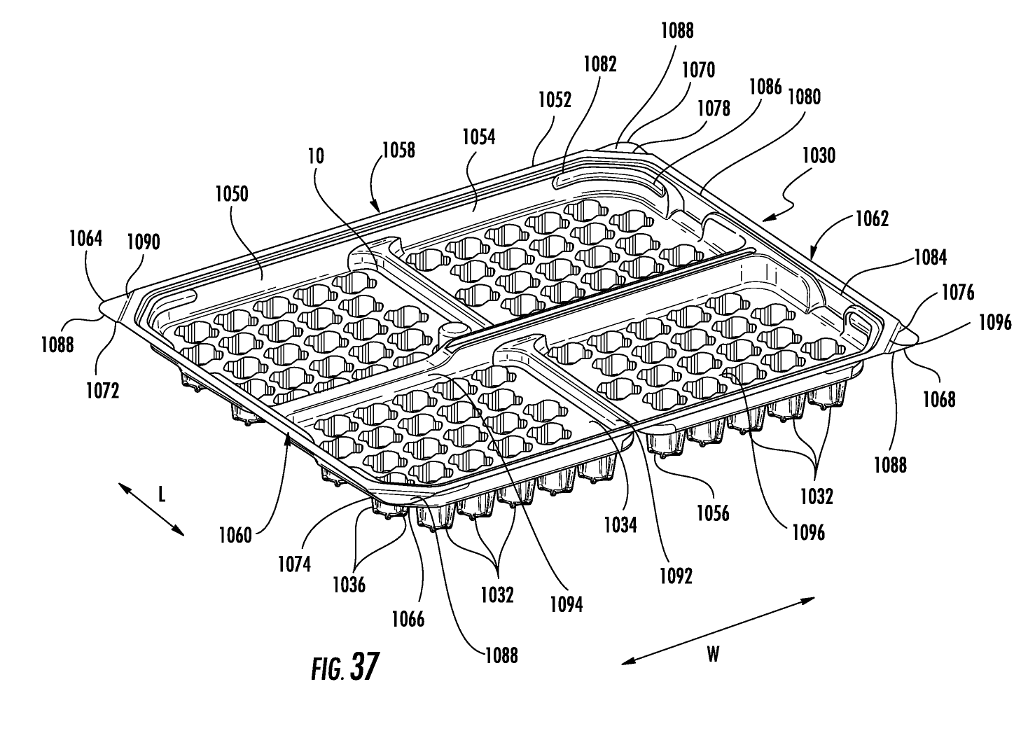

The processing lid 200 further includes a flexible handle 230, as shown in FIGS. 35A-35F. Portions of the top and bottom surface of base 202 may be reserved as handle attachment portions 232, 234. As shown in FIGS. 26 and 27, in the illustrated embodiment the top handle attachment portion 232 is defined by the region including transverse creases 206, and the bottom handle attachment portion 234 is defined by the absence of creases, or a generally flat surface of the base 202. Handle attachment portions 232, 234 extend to aligned regions of the outer edge of the base 202. Handle 230 can be formed of a variety of flexible sheet materials, including polypropylene (PP), polyethylene (PE), polyethylene terephthalate (PET) and polycarbonate (PC). In the illustrated embodiment, the handle 230 is substantially I-shaped. A top portion 236 of the handle 230 attaches to the top handle attachment portion 232 of the processing lid 200 and a bottom portion 238 of the handle 230 attaches to the bottom handle attachment portion 235 of the processing lid. The handle 230 includes a fold 240 separating the top portion 236 and the bottom portion 238. In use, the fold 230 is aligned against the edge of the processing lid 200 separating the top and bottom handle attachment portions 232, 234 and wraps from the top handle attachment portion 232 to the bottom handle attachment portion 234. In one embodiment, the handle 230 is affixed to the top handle attachment portion 232 by removable attachment means, such as removable adhesives or mechanical fasteners such as fingers or hook and loop fasteners, and affixed to the bottom handle attachment portion 234 by permanent attachment means, such as permanent adhesives, welding, or mechanical fasteners such as fingers. This enables the handle to be easily detached from the top surface of the processing lid 200 during removal of the vials 12 from the assembly 10, as described in detail below.

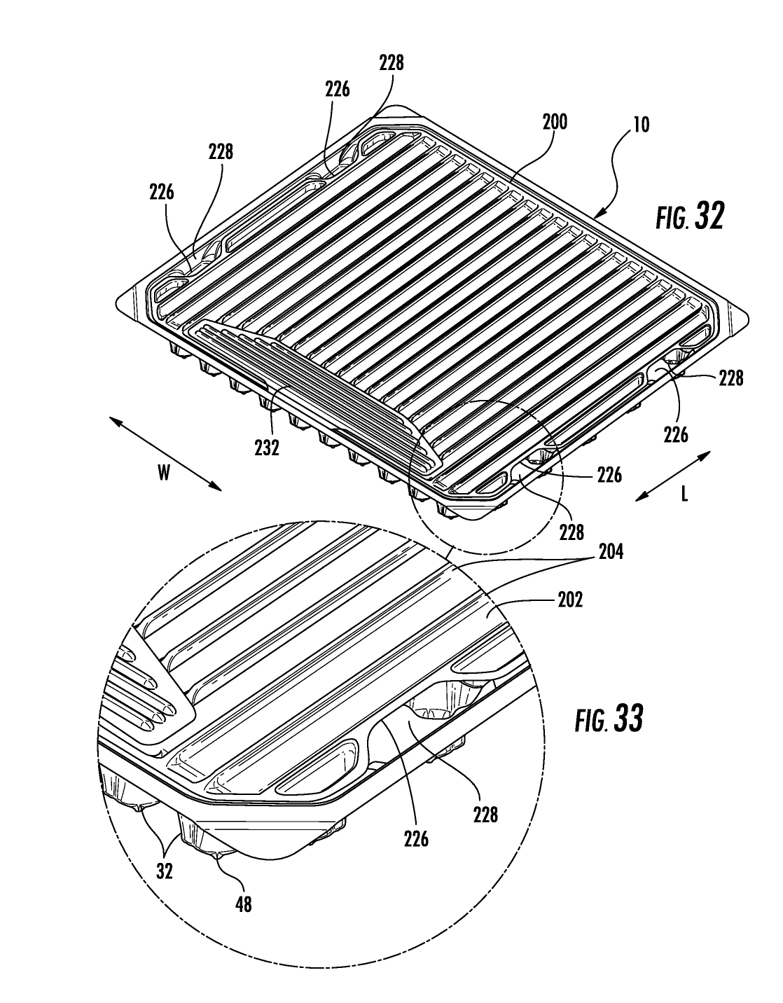

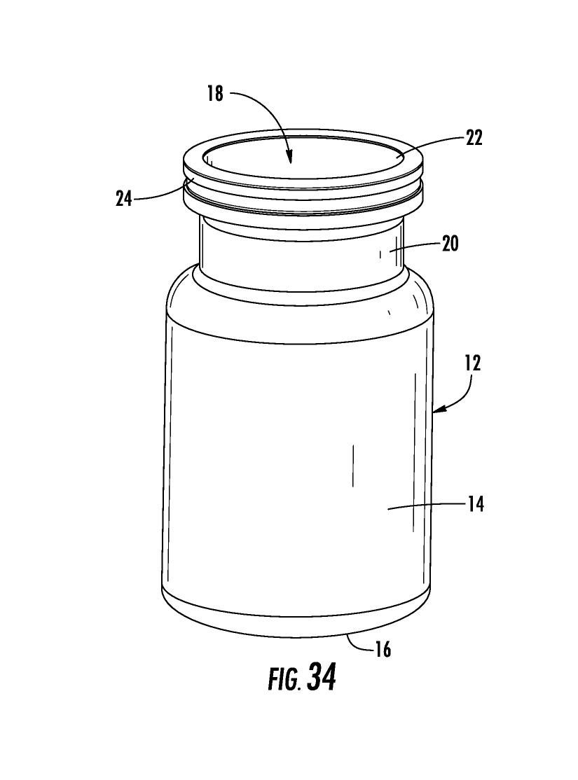

Referring to FIGS. 32 and 33, the tray 30 and the processing lid 200 are shown in engagement with each other, such that the processing lid 200 closes the receptacles 38 and substantially covers and encloses the vials 12 stored therein. As shown, the border 208 of processing lid 200 rests on the shoulder 82 of the tray 30, such that the top surface of the processing lid base 202 and border 208 are substantially flush with the uppermost surface of tray rim 50. A connection is formed between the processing lid 200 and the vial tray 30 substantially about the perimeters thereof, with the exception of the regions where indentations 226 of the processing lid 200 are aligned with interruptions 84 of the tray 30, between which openings 228 are defined.

The assembly 10 including the tray 30 and processing lid 200 can be utilized for vial processing 12 in which gas contacts vial surfaces, including those of the vial interior 18. To achieve this, vials 12 are inserted into the vial tray 30 in an inverted condition, as shown in FIG. 1. The processing lid 200 is placed over the vial tray 30 to cover and substantially enclose the vials 12 within, with the border 208 thereof resting on the shoulder 82 of the tray 30. A sheet 242 of selectively permeable material is placed overtop of the processing lid 200, with the edges 244 of the sheet being removably adhered to the rim 50 of the tray 30. “Selectively permeable material” as used herein is defined as a material that permits permeation of some gases or materials, while prohibiting permeation of others. In one example, the selectively permeable material of the sheet permits permeation of gases while prohibiting permeation of solids and liquids. Such a selectively permeable material may be used, for example, where the processing operation performed on the vials 12 is sterilization, which can take place by exposing the vial surfaces to a sterilizing gas, such as ethylene oxide (EO) or nitrous oxide (N₂O). In one embodiment the sheet 242 is formed of a nonwoven of high-density polyethylene fibers, such as that sold under the trade name TYVEK®. The sheet 242 is adhered to the rim outer wall 52 of the rim 50 in the illustrated embodiment, by removable attachment means, such as an adhesive. In one embodiment the entire bottom surface of the sheet 242 is flood coated with an adhesive. In another embodiment, the surface is zone coated in only the region that will contact the outer wall 52.

As shown in FIG. 36, the sheet 242 completely covers the processing lid 200 and openings 228, to prevent ingress of solid or liquid matter. Gases, such as sterilization gases, can penetrate the sheet 242 and openings 228, and travel through space 152 to come into contact with the vials 12. Gas can then travel to the interior 18 of vials 12 by entering gaps 40 and traveling through channels 114 to vial openings 22.

After vial processing, the vials can be removed from the assembly 10. In one embodiment, vials 12 may be removed from the assembly and transferred to a filling line. This can be achieved according to the procedure shown in FIGS. 35A-35F. Once processing is completed, sheet 242 is removed from the assembly, as shown in FIG. 35A. The sheet 242 can be removed by peeling. In one embodiment, the sheet 242 is adhered to the entire outer wall 52 of the tray rim 50, with the exception of the corner depressions 88. A user can thus grip the sheet at the unadhered portions located above the corner depressions 88 to initiate peeling. The top portion 236 of handle 230 is disengaged from the top handle attachment portion 232 of the processing tray 200, and the handle 230 is unfolded, as shown in FIG. 35B. The entire assembly 10 is then inverted, as shown in FIGS. 35C and 35D. The assembly 10 can then be set on a surface 246, such as the entry portion of a filling line, with the processing tray 200 located at the bottom thereof. The top portion 236 of the handle can then be gripped by a user and slid in the direction shown in FIG. 35E, to remove the processing tray 200 from the assembly 10. This results in the vials 12 sitting in upright positions directly on the surface 246. The tray 30 can then be lifted upwards, as shown in FIG. 35F, leaving the vials 12 sitting on the surface, upright and uncovered, and aligned in the configuration of the tray receptacles 32, in preparation for transfer to a filling line.

In one embodiment, the longitudinal or transverse creases 204, 206 extend downward from the lower surface of the processing lid 200 in a formation to facilitate orientation of the vials 12 for transfer to a filling line. In such an embodiment, the processing lid 200 can be left in place beneath the vials 12 and used as a supporting surface for entry of the vials 12 into the filling line.

A second embodiment of a vial storage and transportation assembly 1010 in accordance with the invention is shown in FIGS. 37-44. This embodiment of the assembly 1010 is similar to that shown in FIGS. 1-36 and described above, and only the differences will be described in detail herein.

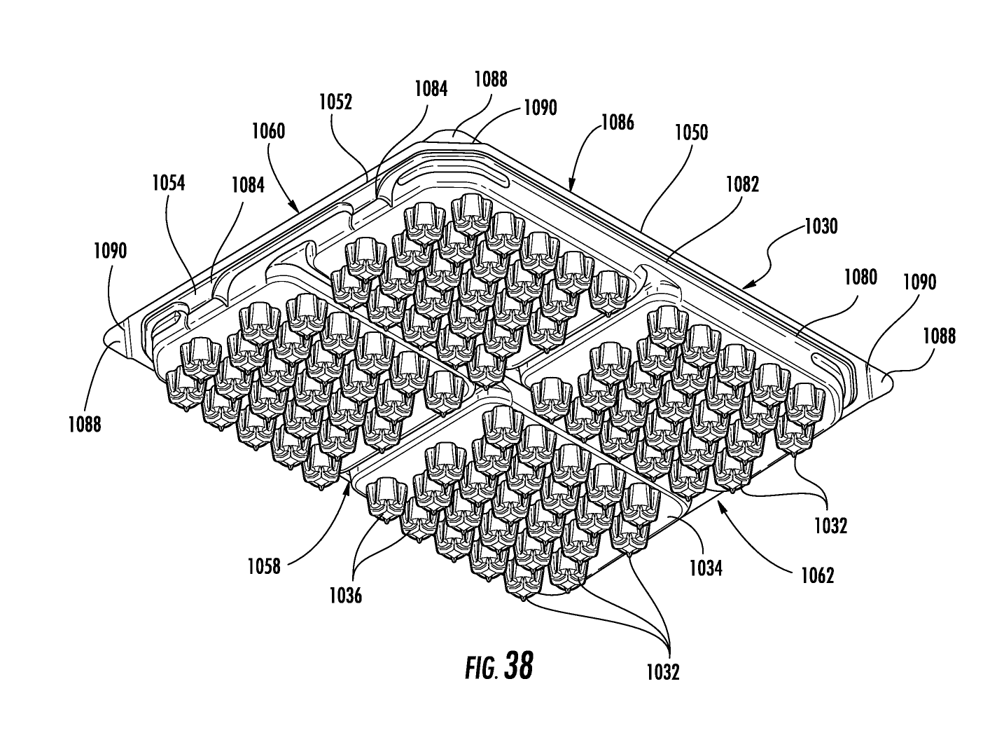

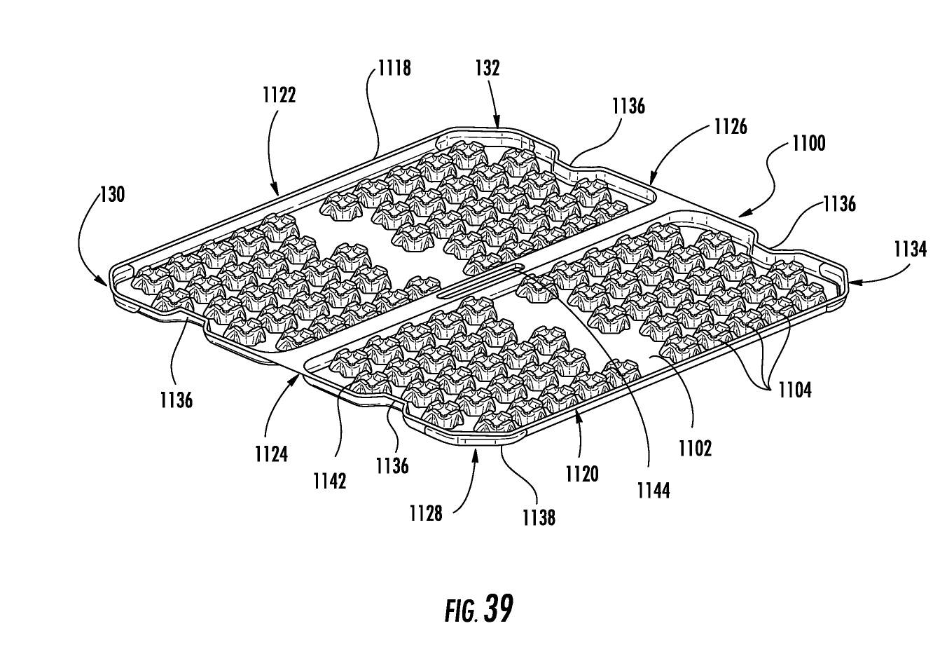

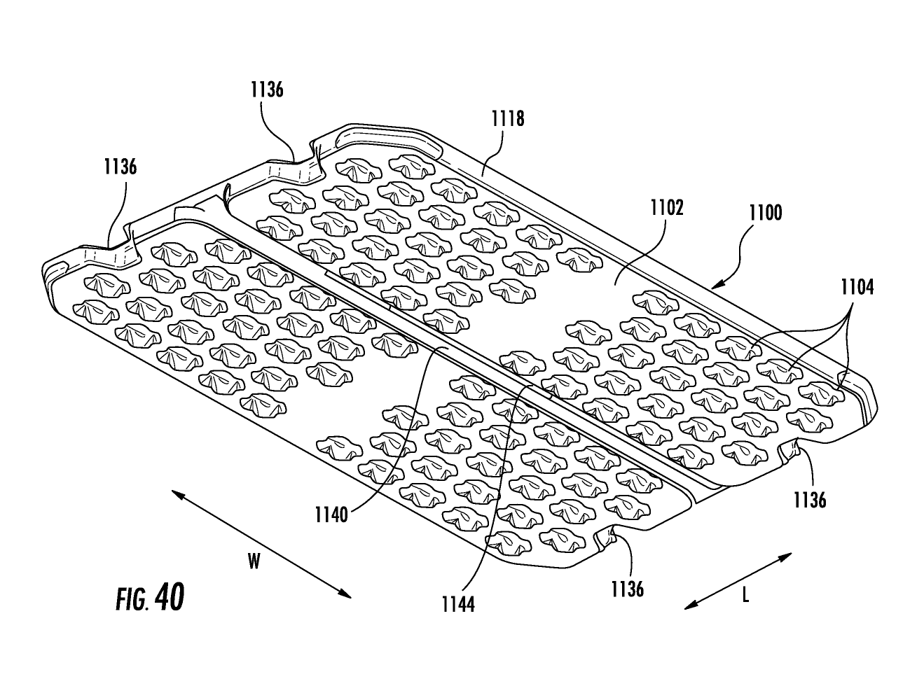

The tray 1030 is shown in detail in FIGS. 37 and 38. As shown, the tray 1030 of this embodiment includes support beams. In the illustrated embodiment, two support beams are provided including a lengthwise extending support beam 1092 and a widthwise extending support beam 1094. The support beams 1092, 1094 extend between opposite sides of the rim 50 and bisect the tray 1030 in the lengthwise and widthwise directions to divide the tray 1030 into four generally equally sized, rectangular sections. The support beams 1092, 1094 extend perpendicular to each other and intersect at a generally central region of the tray 1030. The support beams 1092, 1094 help to add stiffness to the tray 1030.

As shown in FIG. 37 a guide groove 1096 is formed in an upper surface of the widthwise extending beam 1094. The guide groove 1096 facilitates engagement and sliding removal of the processing lid 1200 when preparing vials 1012 stored therein for transfer to a filling line, as described in detail below.

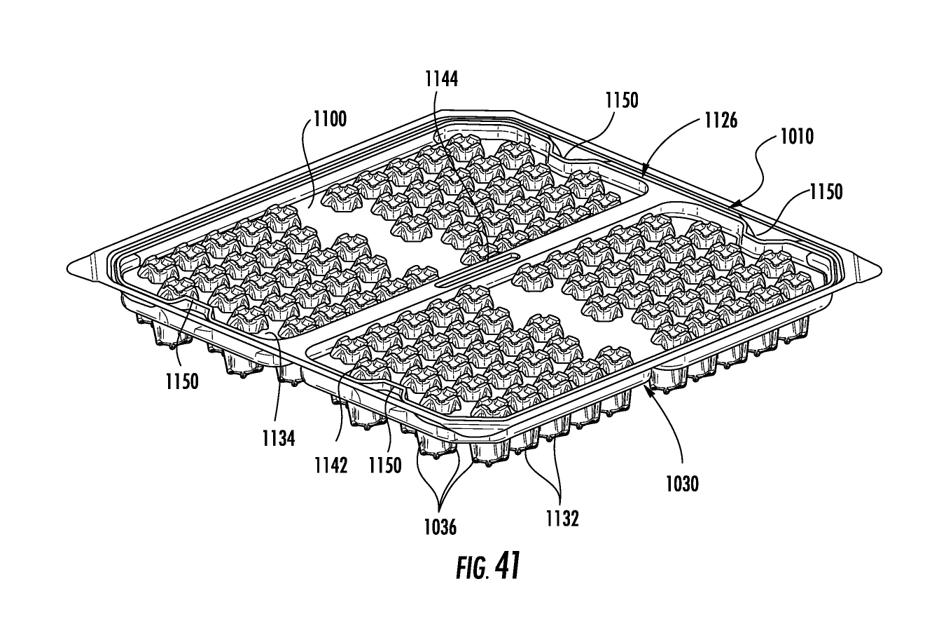

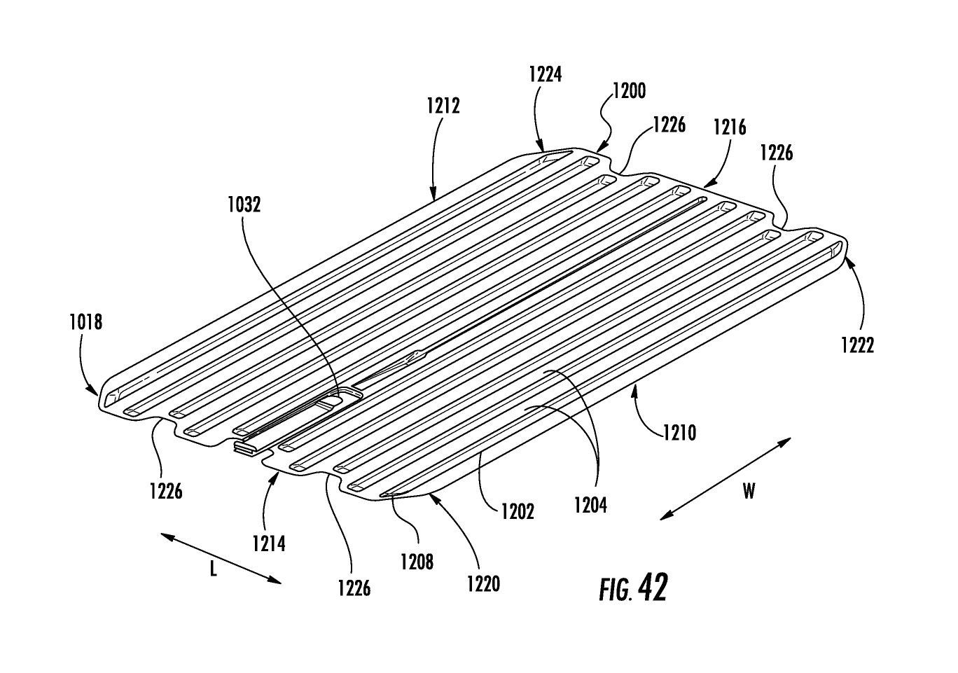

A second embodiment of a transport lid 1100 according to the invention is shown in detail in FIGS. 39 and 40. In this embodiment, a widthwise extending beam 1142 extends upward from the top surface of the transport lid 1100, as shown in FIG. 39, to add rigidity to the transport lid 1100 and facilitate alignment with the tray 1030, by aligning with the widthwise extending beam 1094 of the tray 1030 when engaging the transport lid 1100 with the tray 1030, as shown in FIG. 41. The widthwise extending beam 1142 forms an elongate indentation 1140 on the underside of the transport lid 1100, as shown in FIG. 40. When the transport lid 1100 is engaged with the tray 1030, the widthwise extending beam 1094 of the tray is received by the elongate indentation 1140 of the transport lid. A downwardly projecting snap 1144 is formed within the elongate indentation 1140 and fits within the guide groove 1096 to help retain the transport lid 1100 on the tray 1030 when engaged therewith.

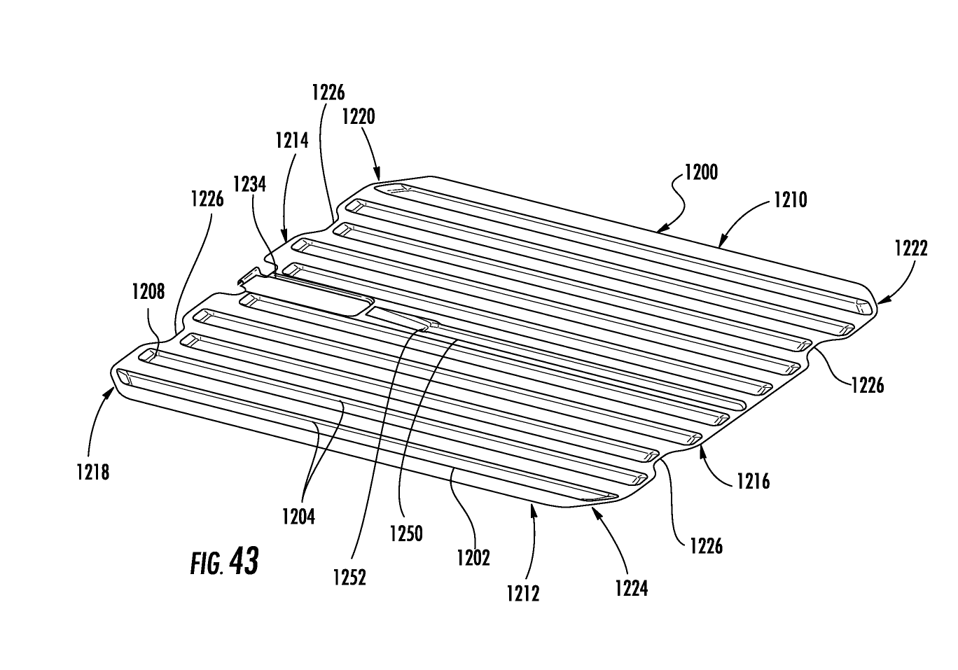

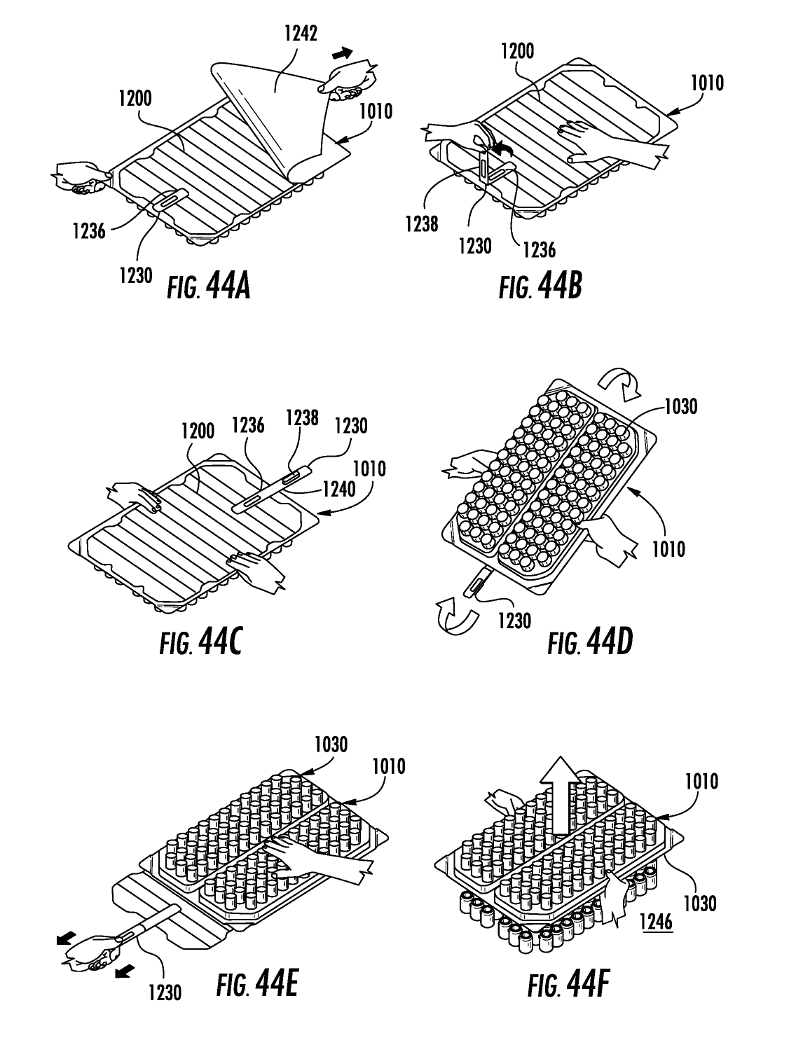

A second embodiment of a processing lid 1200 according to the invention is shown in detail in FIGS. 42 and 43. This embodiment of the processing lid 1200 includes only transverse creases 1206 extending in the widthwise direction of the processing lid 1200, and omits the longitudinal creases 204 of FIG. 26. In another embodiment, the processing lid 1200 could include only longitudinal creases and not transverse creases.

The flexible handle 1230 of the processing lid of FIGS. 42 and 43 is formed as an elongate strip, rather than having an I-shape, and handle attachment portions 1232, 1234 of the processing lid 1200 are modified in shape to accommodate the strip-shaped handle 1230. A handle lift tab 1248 may be provided on the top handle attachment portion 1232 to facilitate removal.

Referring to FIG. 45, the tray 1030 and the processing lid 1200 are shown in engagement with each other. The tray 1030 and processing lid 1200 engage in substantially the same manner as in the embodiment of FIGS. 1-37. Additionally a rail 1250 extending downward from the bottom surface of the processing lid 1200 and extending in the widthwise direction engages the guide groove 1096 of the tray 1030. Engagement of the rail 1250 and the guide groove 1096 help to secure the processing lid 1200 on the tray and allow for sliding removal therefrom, by sliding the processing lid 1200 and in turn the rail 1250 out from the guide groove 1096. The rail 1250 joins with the base 1202 by way of a ramp 1252, as shown in FIG. 43.

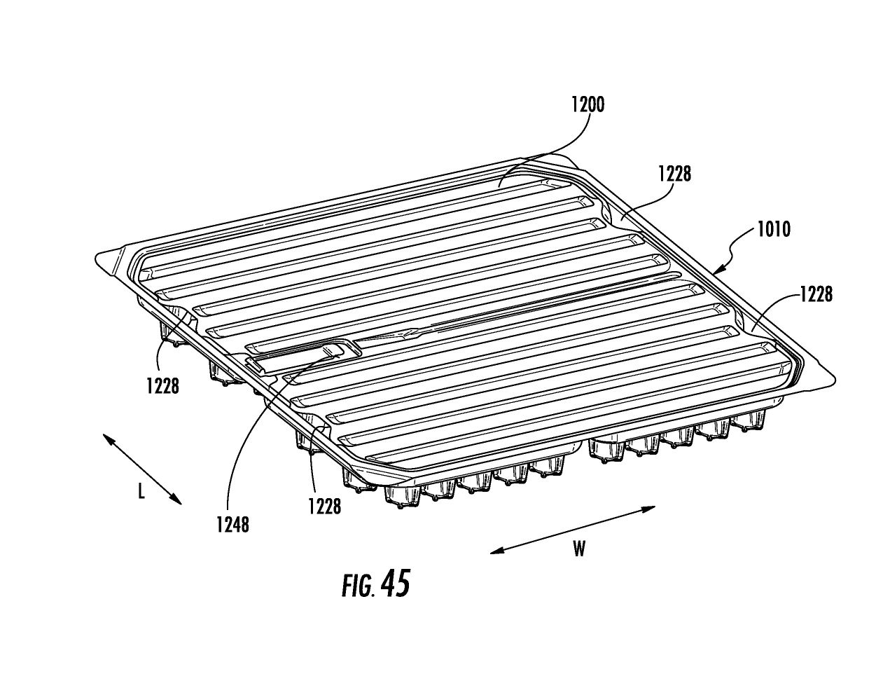

The vials 12 can be removed from the assembly and transferred to a filling line according to the procedure shown in FIGS. 44A-F. Once processing is completed, sheet 1242 is removed from the assembly, as shown in FIG. 44A. The sheet 1242 can be removed by peeling. In one embodiment, the sheet 1242 is adhered to the entire outer wall 1052 of the tray rim 1050 with the exception of corner depressions 1088. A user can thus grip the sheet at the unadhered portions located above the corner depressions to initiate peeling. The top portion 1236 of the handle 1230 is disengaged from the top handle attachment portion 1232, for example by gripping and pulling the handle lift tab 1248, and the handle 1230 is unfolded, as shown in FIG. 44B. The entire assembly 1010 is then inverted, as shown in FIGS. 44C and 44D. The assembly 1010 can then be set on a surface 1246, such as the entry portion of a filling line, with the processing tray 1200 located at the bottom thereof. The top portion 1236 of the handle can then be gripped by a user and slid in the direction shown in FIG. 44E, to remove the processing tray 1200 from the assembly 1010. This results in the vials 12 sitting in upright positions directly on the surface 1246. The tray 1030 can then be lifted upwards, as shown in FIG. 44F, leaving the vials 12 sitting on the surface, upright and uncovered, and aligned in the configuration of the tray receptacles 1032, in preparation for transfer to a filling line.

The components of the assembly 10, 1010, including the vial tray 30, 1030, transport lid 100, 1100 and processing lid 200, 1200 can formed of various materials, including polymeric materials such as PE, PP, PET or PC. Other suitable materials would be recognizable to a person of ordinary skill in the art.

While the preferred embodiments of the invention have been described in detail above, the invention is not limited to the specific embodiments described, which should be considered as merely exemplary.

What is claimed is:

1-64. (canceled)

65. A vial storage and transportation assembly, comprising:
a vial tray having a substantially planar base and a plurality of receptacles extending downwardly therefrom, each of the receptacles having a substantially cylindrical body closed off by a bottom wall having a downwardly extending protrusion; and
a transport lid having a substantially planar base and a plurality of bumps extending upwardly therefrom, each of the bumps having a substantially cylindrical body closed off by a top wall having a downwardly extending indentation;
wherein each of the indentations is configured to receive a selected one of the protrusions of a second assembly, so as to permit stacking of multiple assemblies.

66. The vial storage and transportation assembly of claim 65, wherein the cylindrical bodies of the bumps and receptacles each comprise a plurality of longitudinal ribs extending in axial directions thereof.

67. The vial storage and transportation assembly of claim 65, wherein each protrusion comprises a central portion and a plurality of radially outwardly extending ribs.

68. The vial storage and transportation assembly of any one of claim 65, wherein each indentation comprises a central portion and a plurality of radially outwardly extending channels.

69. The vial storage and transportation assembly of claim 66, wherein each protrusion comprises a central portion and a plurality of radially outwardly extending ribs, each of the radially outwardly extending ribs terminating at a circumferential position between two adjacent longitudinal ribs.

70. (canceled)

71. (canceled)

72. A method of transporting a plurality of vials, comprising:
providing a first vial storage and transportation assembly including a vial tray having a substantially planar base and a plurality of receptacles extending downwardly therefrom, each of the receptacles having a substantially cylindrical body closed off by a bottom wall having a downwardly extending protrusion, and a transport lid having a substantially planar base and a plurality of bumps extending upwardly therefrom, each of the bumps having a substantially cylindrical body closed off by a top wall having a downwardly extending indentation, wherein each of the indentations is configured to receive a selected one of the protrusions of a second vial storage and transportation assembly, so as to permit stacking of multiple assemblies;
providing a plurality of vials, each having an interior and an opening located at a top portion thereof and leading to the interior;
inverting and placing a top portion of each of the vials within the receptacles such that the opening of each vial faces the bottom wall of one of the receptacles;
placing the transport lid over the vials and in engagement with the vial tray, such that the vials are substantially enclosed between the vial tray and the transport lid, such that one of the bumps houses a bottom portion of each of the vials; and
transporting the vials within the first assembly.

73. The method of claim 72, further comprising stacking the second vial storage and transportation assembly upon the first vial storage and transportation assembly by placing the vial tray of the second vial storage and transportation assembly upon the transport lid of the first vial storage and transportation assembly, with the protrusions of the second vial storage and transportation assembly received by the indentations of the first vial storage and transportation assembly.

74-81. (canceled)

82. A method of transporting and processing a plurality of vials, comprising:
providing a vial storage and transportation assembly including a vial tray having a substantially planar base and a plurality of receptacles extending downwardly therefrom, a transport lid having a substantially planar base and a plurality of bumps extending upwardly therefrom, and a processing lid that engages the vial tray interchangeably with the transport lid;
providing a plurality of vials, each having an interior and an opening located at a top portion thereof and leading to the interior;
inverting and placing a top portion of each of the vials within the receptacles such that the opening of each vial faces the bottom wall of one of the receptacles;
placing the transport lid over the vials and in engagement with the vial tray, such that the vials are substantially enclosed between the vial tray and the transport lid, and one of the bumps houses a bottom portion of each of the vials; and
transporting the vials within the assembly;
removing the transport lid from the vial tray;
placing the processing lid over the vials and in engagement with the vial tray, such that the vials are substantially enclosed between the vial tray and the processing lid; and
subjecting the vials to a processing operation within the assembly.
